(19) United States
(12) Patent Application Publication
(10) Pub. No.: US 2015/0309584 A1
(43) Pub. Date: Oct. 29, 2015

(54) INPUT CONTROL DEVICE AND METHOD

(71) Applicant: FUJITSU LIMITED, Kawasaki-shi (JP)

(72) Inventors: Jun Kawai, Kawasaki (JP); Toshiaki Ando, Yokohama (JP)

(21) Appl. No.: 14/686,493

(22) Filed: Apr. 14, 2015

(30) Foreign Application Priority Data
Apr. 25, 2014 (JP) 2014-092079

(51) Int. Cl. G06F 3/01; G06F 3/0346

(52) U.S. Cl. CPC G06F 3/017; G06F 3/0346

(57) ABSTRACT

A processor recognizes a shape of an indicator that performs an operation in a space on an object to be operated that is displayed on a display surface. The processor specifies an operation assigned to the recognized shape of the indicator. The processor changes a size of the space in which the operation is performed in accordance with the specified operation.

### CROSS-REFERENCE TO RELATED APPLICATION

This application is based upon and claims the benefit of priority of the prior Japanese Patent Application No. 2014-092079, filed on Apr. 25, 2014, the entire contents of which are incorporated herein by reference.

### FIELD

The embodiments discussed herein are related to an input control device and a control method.

### BACKGROUND

An example of an input operation method using a three-dimensional space is an operation using a user's gesture. As an example, a technology has been proposed in which a command that corresponds to a user's gesture is determined, and an image object displayed on a screen is operated on the basis of the determined command.

In addition, a technology has been proposed in which a sensor is attached to a glove, and a desired operation is instructed in accordance with a shape or a position of the glove. Further, a technology has been proposed in which a three-dimensional space spreading in front of a screen is divided into three layers, and mouse commands are assigned to the respective layers (see, for example, Patent Documents 1-3).

[Patent Document 1] Japanese National Publication of International Patent Application No. 2011-517357

[Patent Document 2] Japanese Laid-open Patent Publication No. 06-12177

[Patent Document 3] Japanese Laid-open Patent Publication No. 2004-303000

### SUMMARY

According to an aspect of the embodiments, an input control device includes a processor that recognizes a shape of an indicator that performs an operation in a space on an object to be operated that is displayed on a display surface, specifies an operation assigned to the recognized shape of the indicator, and changes a size of the space in which the operation is performed in accordance with the specified operation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example (no. 1) of a system that performs an input operation.

FIG. 2 illustrates an example (no. 2) of a system that performs an input operation.

FIG. 3 illustrates an example (no. 3) of a system that performs an input operation.

FIG. 4 illustrates an example (no. 4) of a system that performs an input operation.

FIG. 5 illustrates an example of a hardware configuration of a processing device.

FIG. 6 illustrates an example of a functional block of a processing device.

FIG. 7 illustrates examples of shapes of an indicator.

FIG. 8 illustrates an example of a selection space.

FIG. 9 illustrates an example of an operation space.

FIG. 10 illustrates examples of operations assigned to an indicator.

FIG. 11 is a flowchart (no. 1) illustrating an example of a flow of a process according to the embodiment.

FIG. 12 is a flowchart (no. 2) illustrating an example of a flow of a process according to the embodiment.

FIG. 13 is a flowchart (no. 3) illustrating an example of a flow of a process according to the embodiment.

FIG. 14 is a flowchart (no. 4) illustrating an example of a flow of a process according to the embodiment.

FIG. 15 is a flowchart (no. 5) illustrating an example of a flow of a process according to the embodiment.

FIGS. 16A through 16F illustrate an example of selection of an object displayed on a display surface.

FIG. 17 illustrates an example of a case in which an operable space is expanded to the maximum.

FIG. 18 illustrates examples of three-dimensional models of a recognizable space and an operable space.

FIG. 19 is a diagram (no. 1) explaining a concrete example according to the embodiment.

FIG. 20 is a diagram (no. 2) explaining a concrete example according to the embodiment.

FIG. 21 is a diagram (no. 3) explaining a concrete example according to the embodiment.

FIG. 22 is a diagram (no. 4) explaining a concrete example according to the embodiment.

FIG. 23 is a diagram (no. 5) explaining a concrete example according to the embodiment.

FIG. 24 is a diagram (no. 6) explaining a concrete example according to the embodiment.

FIG. 25 is a diagram (no. 7) explaining a concrete example according to the embodiment.

FIG. 26 is a diagram (no. 8) explaining a concrete example according to the embodiment.

FIGS. 27A and 27B are a diagram explaining the first application example.

FIG. 28 is a diagram explaining the second application example.

FIG. 29 is a diagram explaining the fourth application example.

FIG. 30 is a diagram explaining the fifth application example.

FIG. 31 is a diagram (no. 1) explaining the sixth application example.

FIGS. 32A and 32B are a diagram (no. 2) explaining the sixth application example.

FIG. 33 is a diagram (no. 1) explaining the seventh application example.

FIG. 34 is a diagram (no. 2) explaining the seventh application example.

FIG. 35 is a diagram (no. 3) explaining the seventh application example.

FIG. 36 is a diagram (no. 4) explaining the seventh application example.

FIG. 37 is a diagram explaining the eighth application example.

### DESCRIPTION OF EMBODIMENTS

### Examples of a System that Performs an Information Input Operation

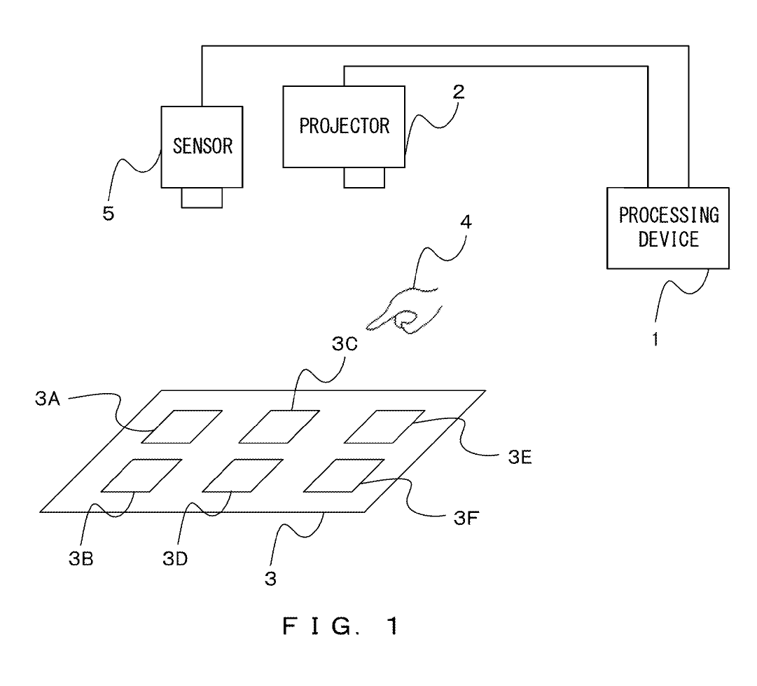

Embodiments are described below with reference to the drawings. FIG. 1 illustrates an example of a system that performs information input using a three-dimensional space. A processing device 1 performs a prescribed input operation process in reply to a user's instruction using the three-dimensional space. The processing device 1 is an example of an input control device.

The processing device 1 is connected to a projector 2. The projector 2 projects information on a display surface 3. The projector 2 is an example of a display device. A screen or the like, for example, may be employed as the display surface 3. The display surface 3 is an example of a display unit.

An indicator 4 exists between the projector 2 and the display surface 3. The processing device 1 detects a shape, a motion, a position and the like of the indicator 4, and detects an input operation based on the indicator 4. In the embodiment, the indicator 4 is fingers of a user who performs an input operation. The user performs the input operation by operating the indicator 4 in the three-dimensional space.

A sensor 5 recognizes the indicator 4. The sensor 5 recognizes the position, the shape, the motion and the like of the indicator 4. A distance sensor, a depth sensor or the like may be employed as the sensor 5. A camera may be employed instead of the sensor 5.

Objects 3A-3F are displayed on the display surface 3 by the projector 2. The objects 3A-3F are examples of objects to be operated. Examples of the objects 3A-3F are icons or the like. The number of objects displayed on the display surface 3 is not limited to six. Information other than the objects 3A-3F may be displayed on the display surface 3.

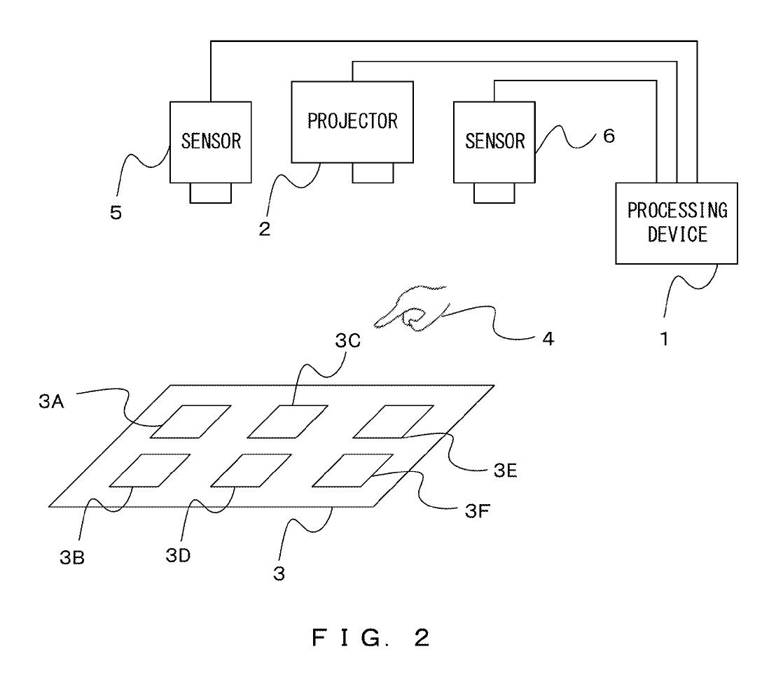

FIG. 2 illustrates an example in which a sensor 6 is added to the configuration illustrated in FIG. 1. Accordingly, in the case illustrated in FIG. 2, the position, the shape, the motion and the like of the indicator 4 can be recognized using two sensors, the sensor 5 and the sensor 6. Because the position, the shape, the motion and the like of the indicator 4 are recognized by a stereo camera, recognition accuracy of the indicator 4 is increased more greatly than that in the case illustrated in FIG. 1.

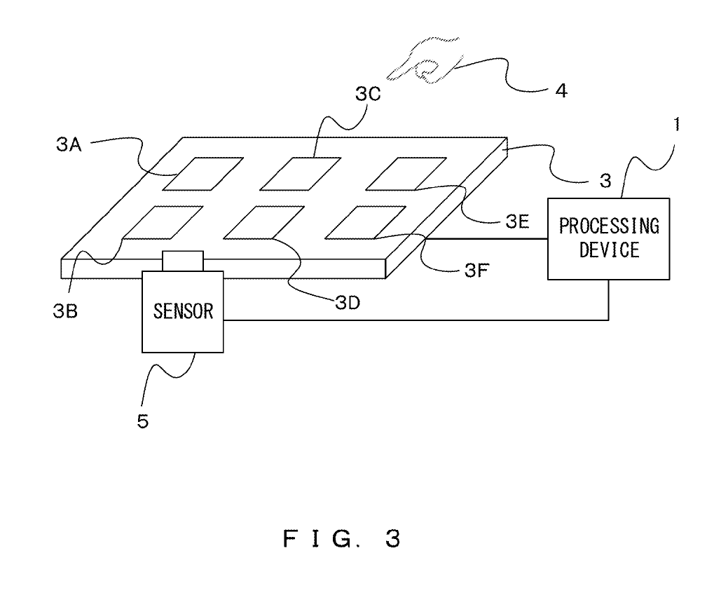

FIG. 3 illustrates an example of a case in which the display surface 3 is a display. The display is connected to the processing device 1, and objects 3A-3F are displayed on the display surface 3 under the control of the processing device 1. In the example illustrated in FIG. 3, the projector 2 is not used.

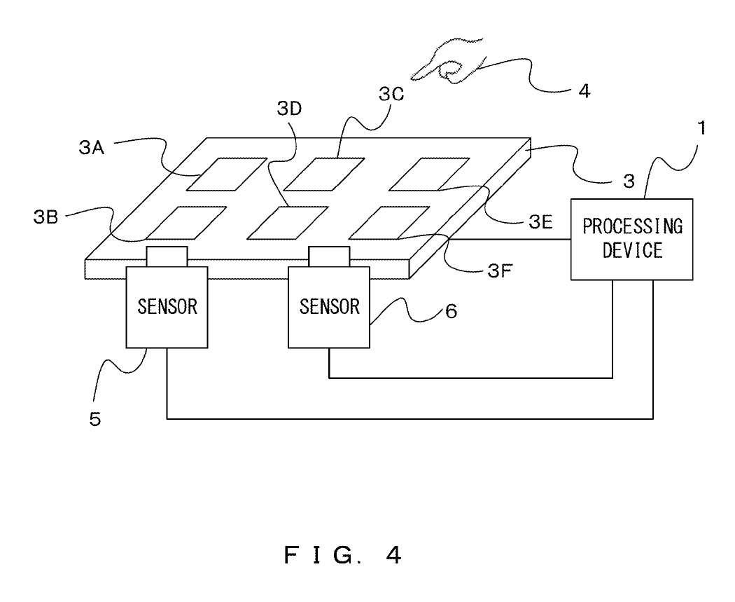

FIG. 4 illustrates an example of a case in which the display surface 3 is a display, and has a stereo sensor. A case in which the configuration illustrated in FIG. 1 is employed as a system that performs an information input operation is described below. However, as the system that performs the input operation, the configuration illustrated in one of FIG. 2 through FIG. 4 may be employed.

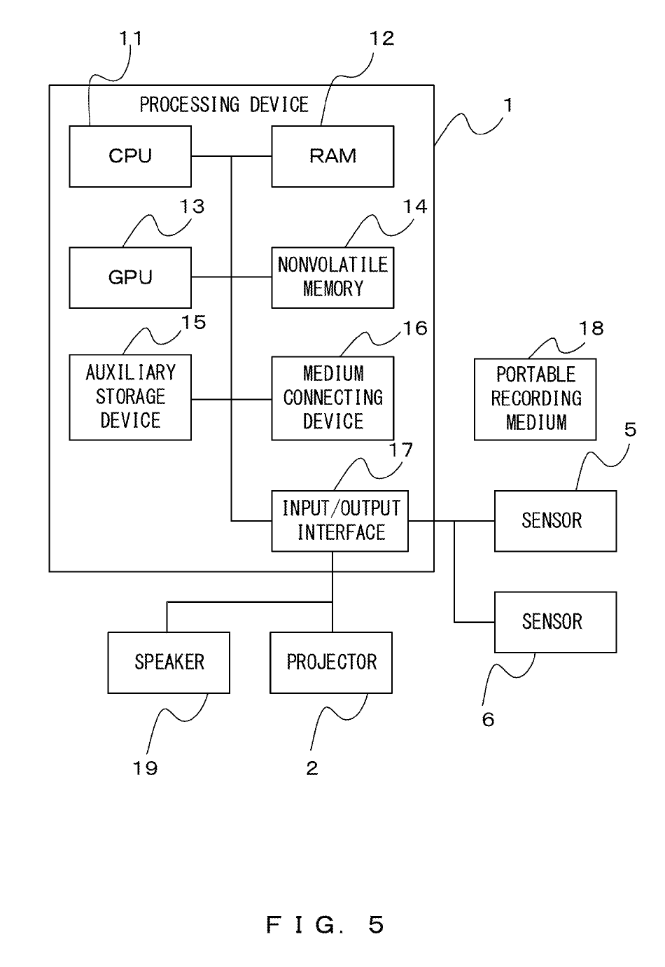

An example of a hardware configuration of the processing device 1 is described next. As illustrated in the example of FIG. 5, the processing device 1 includes a Central Processing Unit (CPU) 11, a Random Access Memory (RAM) 12, a Graphics Processing Unit (GPU) 13, a nonvolatile memory 14, an auxiliary storage device 15, a medium connecting device 16, and an input/output interface 17.

The CPU 11 and the GPU 13 are arbitrary processing circuits such as a processor. The CPU 11 executes a program loaded into the RAM 12. A control program for realizing processes according to the embodiment may be employed as the executed program. A Read Only Memory (ROM), for example, may be employed as the nonvolatile memory 14.

The auxiliary storage device 15 stores arbitrary information. A hard disk drive, for example, may be employed as the auxiliary storage device 15. A portable recording medium 18 may be connected to the medium connecting device 16.

A portable memory or optical disk (e.g., a Compact Disk (CD) or a Digital Versatile Disk (DVD)) may be employed as the portable recording medium 18. The control program for performing the processes according to the embodiment may be stored in the computer-readable portable recording medium 18.

The RAM 12, the portable recording medium 18 and the like are examples of a computer-readable tangible recoding medium. These tangible recoding mediums are not transitory mediums such as a signal carrier. The input/output interface 17 is connected to the projector 2, the sensor 5, the sensor 6, and a speaker 19. The speaker 19 is a device that generates sound.

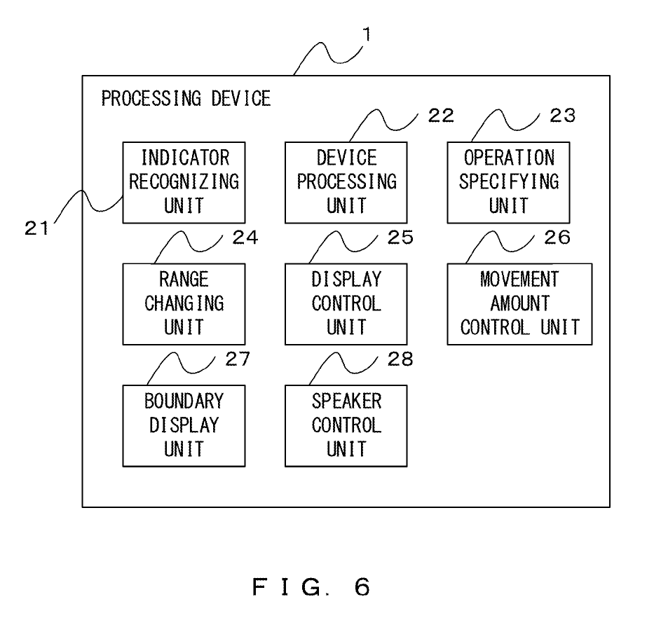

An example of a functional block of the processing device 1 is described next with reference to FIG. 6. The processing device 1 includes an indicator recognizing unit 21, a device processing unit 22, an operation specifying unit 23, a range changing unit 24, a display control unit 25, a movement amount control unit 26, a boundary display unit 27, and a speaker control unit 28.

The sensor 5 senses the indicator 4. The indicator recognizing unit 21 recognizes the position, the shape, the motion and the like of the indicator 4 on the basis of the result sensed by the sensor 5. In a case in which the sensor 5 performs constant sensing, the indicator recognizing unit 21 recognizes the position, the shape, the motion and the like of the indicator 4 in real time. The indicator recognizing unit 21 is an example of a recognizing unit.

The device processing unit 22 performs various controls. The device processing unit 22 is an example of a processing unit. The operation specifying unit 23 specifies an operation on the basis of the shape, or a combination of the shape and the motion of the indicator 4 that the indicator recognizing unit 21 recognizes. The operation specifying unit 23 is an example of a specifying unit.

An operation has been assigned to the shape, or the combination of the shape and the motion of the indicator 4, and the operation specifying unit 23 specifies the operation assigned to the recognized shape or combination of the shape and the motion of the indicator 4. A correspondence relationship between the indicator 4 and the operation may be stored in, for example, the RAM 12 illustrated in FIG. 5, or the like.

The range changing unit 24 changes a size of a space that the indicator 4 operates, in accordance with the operation specified by the operation specifying unit 23. The range changing unit 24 may widen the space that the indicator 4 operates, or may narrow the space.

The display control unit 25 performs control such that various pieces of information are displayed on the display surface 3. In the cases illustrated in FIG. 1 through FIG. 4, the display control unit 25 performs control so as to display the objects 3A-3F on the display surface 3. The boundary display unit 27 performs control so as to explicitly display a space in which an information input operation can be performed using the indicator 4 (hereinafter referred to as an “operable space”).

The speaker control unit 28 controls the speaker 19 so as to generate sound when the indicator 4 is located at a boundary of the operable space. The sound generated by the speaker 19 is a kind of warning sound. The speaker control unit 28 is an example of a sound source control unit that controls a speaker (sound source). The speaker control unit 28 may control the volume of the sound.

When an object that the indicator 4 is operating approaches the boundary of the operable space, the movement amount control unit 26 performs control such that a movement amount of the object is smaller than a movement amount of the indicator 4. The respective units described above in the processing device 1 may be executed by, for example, the CPU 11.

### <Examples of the Shapes of the Indicator>

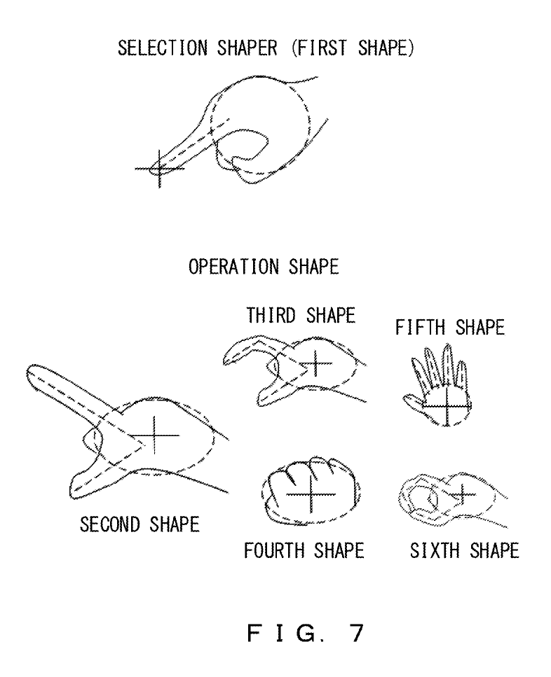

Examples of the shapes of the indicator are described next using the examples illustrated in FIG. 7. The shape of the indicator mainly includes a selection shape and an operation shape. The selection shape is a shape for selecting the objects 3A-3F displayed on the display surface 3. The operation shape is a shape of the indicator 4 assigned to the operation.

In the example of FIG. 7, the selection shape is illustrated as a first shape. The first shape is a shape in which the forefinger of the indicator 4 is extended. A point of the indicator 4 that is a reference of selection and operation is referred to as an “indication point”. In the example of FIG. 7, the tip of the forefinger is the indication point (in FIG. 7, an intersection of a cross expresses the indication point). The indication point is not limited to the tip of the forefinger.

In the example of FIG. 7, the operation shape includes five shapes, a second shape through a sixth shape. The second shape through the sixth shape have different shapes of the indicator 4. Accordingly, in the embodiment, the indication point of the operation shape is assumed to be a gravity center of the indicator 4.

The selection shape and the operation shape are not limited to the examples illustrated in FIG. 7. The first shape may be different from the shape illustrated in FIG. 7. The second through sixth shapes may be different from the shapes illustrated in FIG. 7. Further, the number of operation shapes may be a number other than five.

### <Example of a Change in an Operation Range Based on a Change in the Indicator>

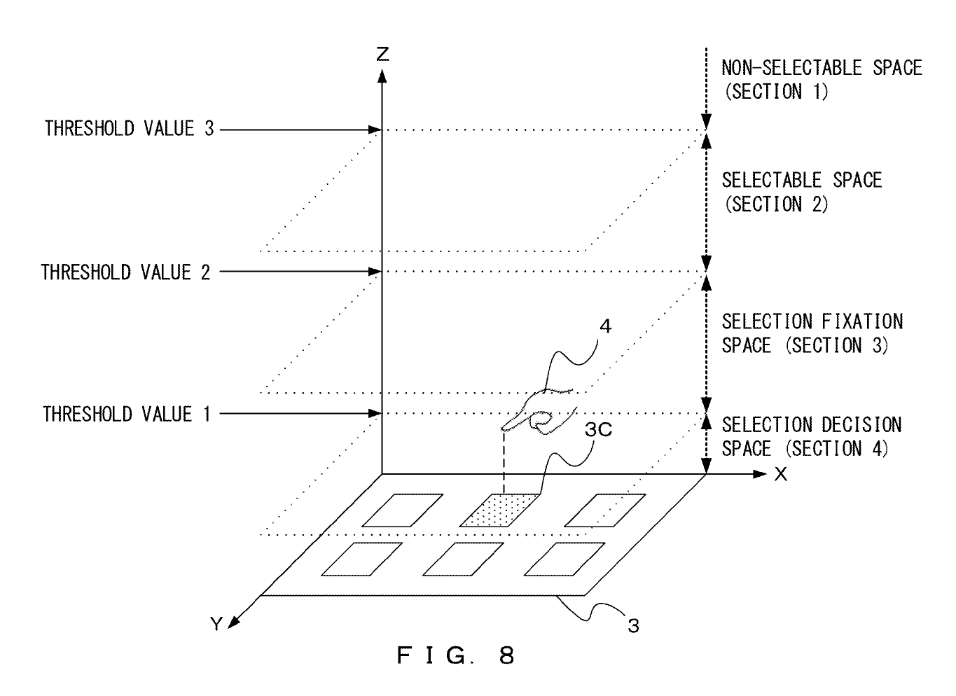

FIG. 8 illustrates an example in which four spaces are set using the display surface 3 as a reference. The four spaces illustrated in FIG. 8 are spaces that are set in order to select an object to be operated that is displayed on the display surface 3. These spaces are also referred to as “selection spaces”. In FIG. 8, the four spaces are illustrated by using an XYZ coordinate system. The display surface 3 is a plane parallel to an XY plane, and is assumed to be located in a coordinate position of zero on the Z axis.

A non-selectable space is described first. The non-selectable space is a space in which an object displayed on the display surface 3 is not selected by the indicator 4. The non-selectable space may be referred to as an “unselected space”. In FIG. 8, a distance in the Z-axis direction of the non-selectable space is illustrated as a section 1. The section 1 is located above a threshold value 3 in the Z-axis direction. When the indicator 4 is located in the non-selectable space, the indicator 4 fails to perform selection on the display surface 3.

A selectable space is described next. The selectable space is a space in which the indicator 4 can select an object displayed on the display surface 3. In FIG. 8, a distance in the Z-axis direction of the selectable space is illustrated as a section 2. The section 2 is located between a threshold value 2 and the threshold value 3 in the Z-axis direction. The selectable space is an example of a first space.

In the selectable space, an object displayed on the display surface 3 can be selected. An object is selected on the basis of a position where the indication point of the indicator 4 is projected on the display surface 3. Accordingly, when the indicator recognizing unit 21 recognizes that the indicator 4 has moved, the position where the indication point of the indicator 4 is projected on the display surface 3 is changed.

When the position where the indication point of the indicator 4 is projected overlaps a position of an object on the display surface 3, the object is selected. However, selection of the object is not determined in the selectable space. When the indicator 4 moves, an object that is selected from among the objects 3A-3F is changed appropriately. When the object is selected, the display control unit 25 highlights the selected object.

A selection fixation space is described next. The selection fixation space is a space in which a selection state of the object selected in the selectable space is fixed. Fixation of the selection state is also referred to as a lock of the selection state. In FIG. 8, a direction in the Z-axis direction of the selection fixation space is illustrated as a section 3. The section 3 is located between a threshold value 1 and the threshold value 2 in the Z-axis direction. The selection fixation space is an example of a second space.

As an example, when the indicator recognizing unit 21 recognizes that the indication point of the indicator 4 has moved from the selectable space to the selection fixation space while the indication point of the indicator 4 selects the object 3C, selection of the selected object 3C is fixed. Accordingly, a state in which the object 3C is selected is fixed.

In the selection fixation space, the object 3C to be operated has been selected. Therefore, the object 3C can be operated when the indicator 4 is located in the selection fixation space. In the embodiment, when a shift is performed from a stage of selecting an object to a stage of operating the selected object, the shape of the indicator 4 is changed in the selection fixation space.

A selection decision space is described next. The selection decision space is a space in which the selected object 3C is determined. When the indicator recognizing unit 21 recognizes that the indication point of the indicator 4 has moved from the selection fixation space to the selection decision space, selection of the object 3C is determined.

In FIG. 8, a distance in the Z-axis direction of the selection decision space is illustrated as a section 4. The section 4 is located between the display surface 3 and the threshold value 1. Therefore, the selection decision space is a space that is closest to the display surface 3. The four spaces described above may be set in advance by the device processing unit 22.

The device processing unit 22 sets the four spaces described above by setting the threshold value 1, the threshold value 2, and the threshold value 3 in advance. The device processing unit 22 may set the threshold value 1, the threshold value 2, and the threshold value 3 to arbitrary values.

In the example of FIG. 8, the section 4 is located in the selection fixation space. Namely, an object is selected, and the selected object is fixed. In the example of FIG. 8, the shape of the indicator 4 is the selection shape (first shape) in order to select an object.

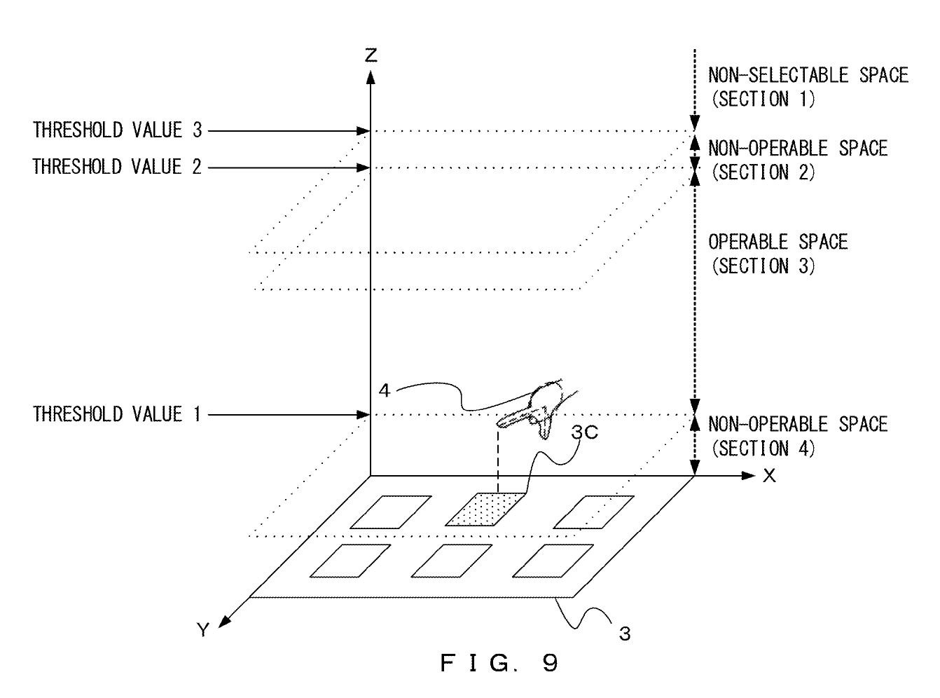

An operation performed on an object for which selection has been fixed is described next with reference to the example of FIG. 9. As illustrated in the example of FIG. 9, the shape of the indicator 4 is changed from the selection shape to the operation shape (second shape). The indicator recognizing unit 21 recognizes that the shape of the indicator 4 has been changed. The shape of the indicator 4 that the indicator recognizing unit 21 recognizes is the second shape in the example of FIG. 9.

Then, the range changing unit 24 changes the setting of the space using the display surface 3 as a reference, on the basis of the shape of the indicator 4 that the indicator recognizing unit 21 has recognized. The space is referred to as an “operation space”. In the example of the operation space illustrated in FIG. 9, the section 1 is a non-selectable space.

The section 2 is a non-operable space. The non-operable space is a space in which objects displayed on the display surface 3 are not operated by the indicator 4. The non-operable space may be referred to as an “unoperated space”. The section 3 is an operable space. The operable space is a space in which the object 3C can be operated by the indicator 4. The section 4 is a non-operable space similarly to the section 2. Also in the section 4, an operation is not performed by the indicator 4.

The range changing unit 24 enlarges a set range of the operable space. Therefore, the range changing unit 24 reduces set ranges of spaces in the section 2 and the section 4. Namely, when the indicator recognizing unit 21 recognizes that the shape of the indicator 4 is the second shape, the range changing unit 24 changes the section 1 through the section 4 so as to have three-dimensional ranges (spaces) that correspond to the operation assigned to the second shape.

In the embodiment, it is assumed that an operation of moving an object and an operation of enlarging or reducing an object are assigned to the second shape. When the indicator 4 moves in a horizontal direction with the second shape maintained, the indicator recognizing unit 21 recognizes a motion of the indicator 4, and the display control unit 25 performs control so as to move the object 3C on the display surface 3 in the horizontal direction.

When the indicator 4 moves in a vertical direction with the second shape maintained, the indicator recognizing unit 21 recognizes the motion of the indicator 4, and the display control unit 25 performs control so as to enlarge or reduce the object 3C on the display surface 3.

Accordingly, when the indicator 4 moves in the vertical direction, an operation of enlarging or reducing the object 3C for which selection has been fixed is performed. Therefore, it is preferable that a space sufficient for an enlarging or reducing operation be secured in the vertical direction.

When the indicator recognizing unit 21 recognizes the second shape, the range changing unit 24 sets a wide space corresponding to the second shape to be an operable space. As a result, a wide space in which the indicator 4 moves can be secured.

The range changing unit 24 changes a size of the operable space in accordance with the shape of the indicator 4 that the indicator recognizing unit 21 recognizes. As an example, when a movement amount for an operation is minute, the range changing unit 24 may set a narrow space to be the operable space.

Accordingly, the operable space is changed in size so as to become a space suitable for the operation assigned to the shape of the indicator 4. As a result, various input operations can be performed, and various input operations using a space can be performed.

### <Examples of Operations Assigned to the Indicator>

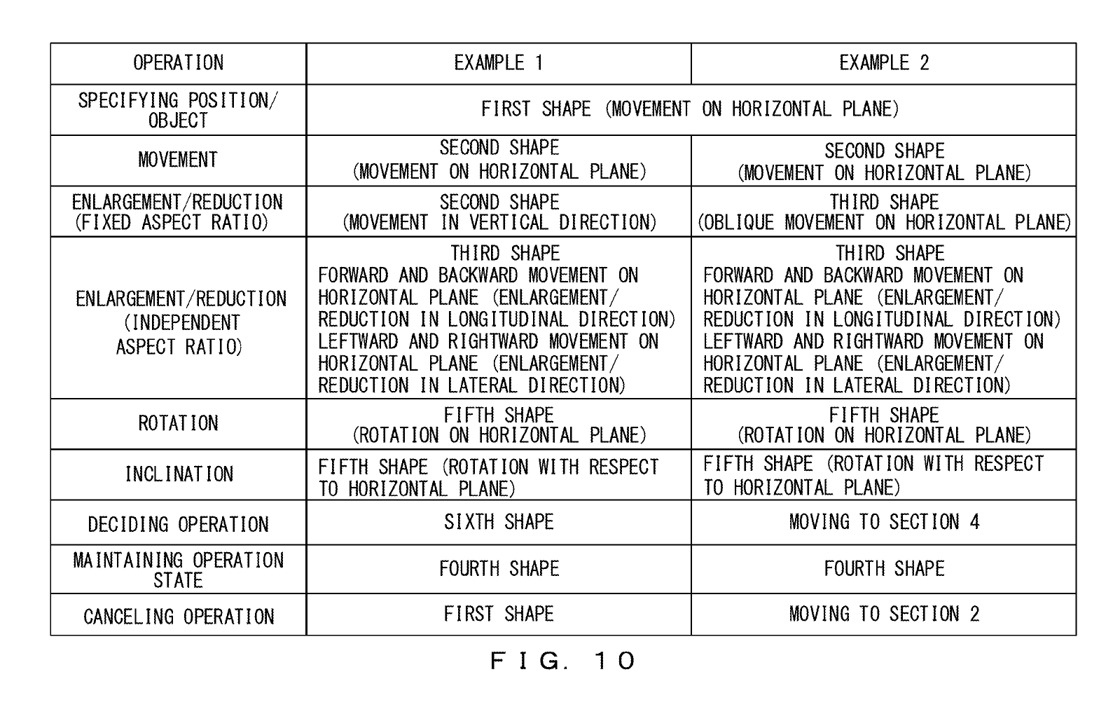

FIG. 10 illustrates examples of operations assigned to the indicator 4. As illustrated in example 1 and example 2 in FIG. 10, an operation is assigned to a combination of the shape and the motion of the indicator 4. Example 1 in FIG. 10 illustrates an example in which an operation is assigned to a motion in the vertical direction (Z-axis direction), and example 2 illustrates an example in which an operation is not assigned to the motion in the vertical direction.

The examples of FIG. 10 include a case in which one operation is assigned to one shape of the indicator 4, and a case in which one operation is assigned to a combination of the shape and the motion of the indicator 4. As an example, in example 1, different operations are assigned to the combination of the second shape and the motion (a movement on a horizontal plane, or a movement in the vertical direction) of the indicator 4. On the other hand, the third shape is assigned to an enlarging or reducing operation at an independent aspect ratio, regardless of the motion.

In both example 1 and example 2 in FIG. 10, the first shape is assigned to position specification and object specification on the display surface 3. Namely, the position specification and the object specification are performed when the indicator 4 has the selection shape.

As an example, in example 1, when the indicator recognizing unit 21 recognizes that the shape of the indicator 4 has been changed to the second shape in the selection fixation space, the operation specifying unit 23 recognizes that the moving operation of the object 3C has been performed or that the enlarging or reducing operation of the object 3C with the aspect ratio fixed has been performed.

When the indicator recognizing unit 21 recognizes that the indicator 4 has moved in the horizontal direction with the second shape maintained, the operation specifying unit 23 specifies that the operation of the indicator 4 is the moving operation of the object 3C. As a result, the display control unit 25 moves the object 3C displayed on the display surface 3.

On the other hand, in example 2, it is assumed that the indicator recognizing unit 21 recognizes that the indicator 4 has obliquely moved on the horizontal plane in the third shape. In this case, the operation specifying unit 23 performs the assigned enlarging or reducing operation at a fixed aspect ratio on the object 3A.

In example 1, an operation has been assigned to the motion in the vertical direction, and therefore the object 3A can be enlarged or reduced by moving the indicator 4 in the vertical direction with the second shape maintained. On the other hand, in example 2, an operation has not been assigned to the motion in the vertical direction, and therefore the object 3A can be enlarged or reduced by changing the shape of the indicator 4 to be the third shape.

In the example illustrated in FIG. 10, “maintaining operation state” expresses an operation by which the indicator 4 can be moved with a current shape and operation maintained. “Canceling operation” expresses an operation by which an operation being performed by the indicator 4 is restored to a state before the operation is started.

### <Example of a Process According to the Embodiment>

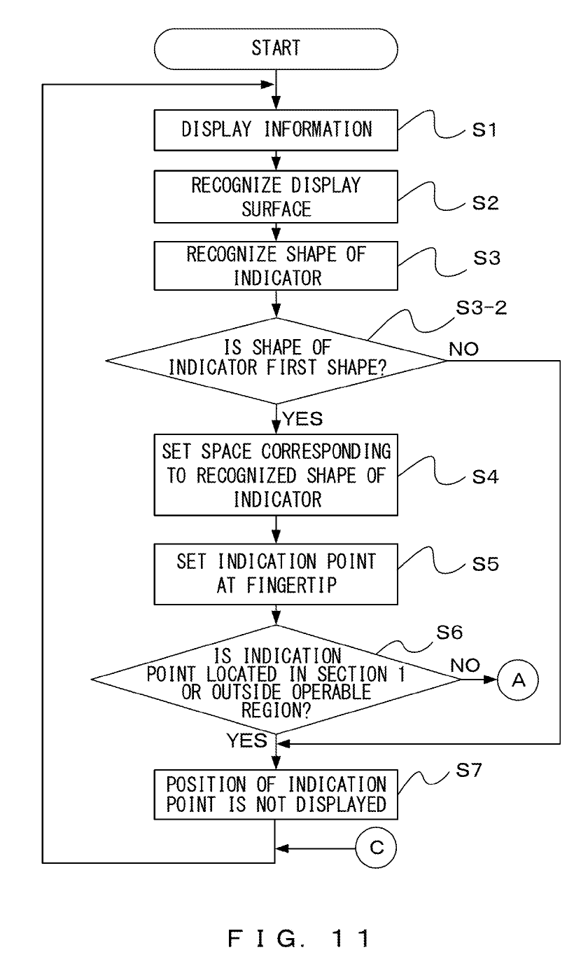

A process according to the embodiment is described next with reference to the flowcharts illustrated in FIG. 11 through FIG. 15. The flowchart illustrated in FIG. 11 is described first. The display control unit 25 displays information on the display surface 3 (step S1). As an example, the display control unit 25 controls the projector 2 so as to display prescribed information on the display surface 3. In the embodiment, the projector 2 is controlled such that the objects 3A-3F are displayed on the display surface 3.

Then, the processing device 1 recognizes a position and a shape on the display surface 3 on the basis of information from the sensor 5 (step S2). When the position and the shape on the display surface 3 have already been recognized, step S2 may be omitted.

The indicator recognizing unit 21 recognizes the shape of the indicator 4 on the basis of the information from the sensor 5 (step S3). The indicator 4 initially has a shape for selecting an object to be operated (the first shape). Hereinafter, the shape for selecting an object is sometimes referred to as a “selection shape”.

The indicator recognizing unit 21 determines whether the recognized shape is the first shape (step S3-2). When the recognized shape is the first shape (“YES” in step S3-2), the process moves on to the next step S4. When the recognized shape is the first shape, (“NO” in step S3-2), the process moves on to step S7.

The device processing unit 22 performs space setting as illustrated in FIG. 8. The device processing unit 22 sets a space that corresponds to the shape of the indicator that has been recognized in step S3 (step S4). Because the indicator 4 has the first shape, the indicator recognizing unit 21 sets the indication point at a fingertip of the forefinger (step S5). The indication point is also referred to as an “operation reference position”.

Then, the indicator recognizing unit 21 determines whether the indication point is located in the section 1 (non-selectable space) or outside an operable region (step S6). In the embodiment, the display control unit 25 projects and displays the position of the indication point in the three-dimensional space based on the display surface 3 on the display surface 3. However, when the indication point is located in the section 1 or outside the operable region (“YES” in step S6), an object to be operated by the indicator 4 fails to be selected. Therefore, in the embodiment, the display control unit 25 does not project or display the position of the indication point on the display surface 3 (step S7).

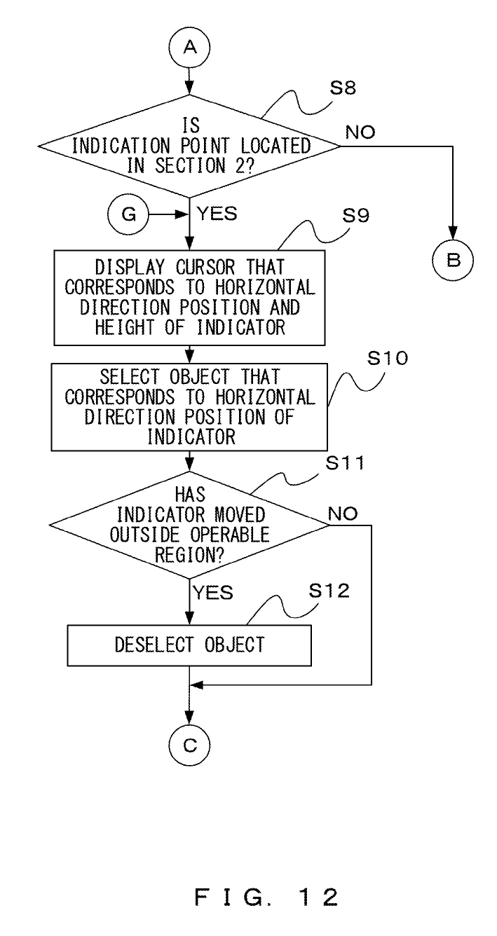

On the other hand, when the indication point is not located in the section 1, the process moves on to “A”. The next process is described with reference to the flowchart illustrated in FIG. 12. The indicator recognizing unit 21 determines whether the indication point is located in the section 2 (selectable space) (step S8).

When the indication point is located in the section 2 (“YES” in step S8), the display control unit 25 displays a cursor that corresponds to a position in the horizontal direction and a height of the indicator (step S9). The indicator recognizing unit 21 recognizes the position in the horizontal direction of the indicator 4. A user moves the indication point in a prescribed object position by moving the indicator 4 in the horizontal direction.

When a position on a horizontal plane that the indicator recognizing unit 21 has recognized overlaps XY coordinates of one of the objects 3A-3F displayed on the display surface 3, an object that corresponds to the horizontal direction position indicated by the indication point is selected (step S10). In the embodiment, the display control unit 25 performs control so as to highlight the selected object.

In step S10, the object is selected. However, the selection of the object is not decided at that moment. Therefore, when the indication point of the indicator 4 moves to a position of another object, the another object is selected. The indicator recognizing unit 21 determines whether the indicator 4 has moved outside the operable region (step S11). The operable region is a space in which the sensor 5 can recognize and operate the indicator 4.

When the indicator 4 moves outside the operable region (“YES” in step S11), the selected object is deselected (step S12). The selected object may also be deselected when the indicator 4 moves to the non-selectable space. When the indicator 4 does not move outside a recognizable space (“NO” in step S11), the selected object is not deselected.

When the decision in step S11 is “NO”, or when the process of step S12 is finished, the process moves on to “C”. When the process moves on to “C”, the process moves on to S1, as illustrated in the example of the flowchart of FIG. 11.

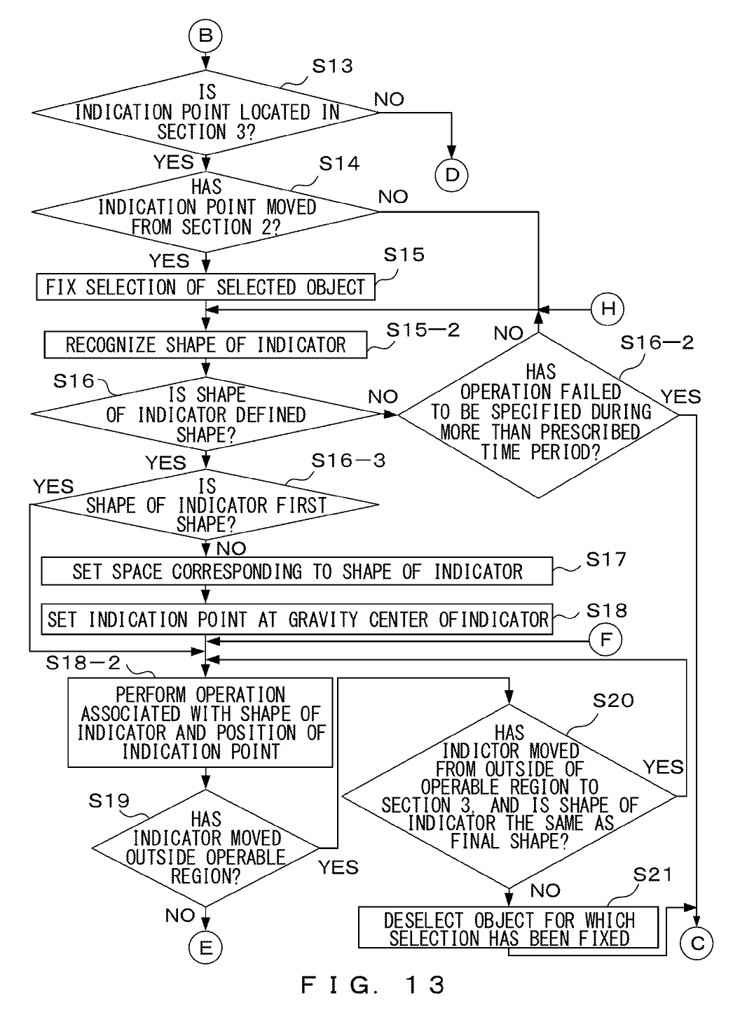

In step S8, when the indication point of the indicator 4 is not located in the section 2 (“NO” in step S8), the process moves on to “B”. The processes after “B” are described by using the flowchart of FIG. 13.

The indicator recognizing unit 21 determines whether the indication point of the indicator 4 is located in the section 3 (step S13). When the indication point of the indicator 4 is located in the section 3 (“YES” in step S13), the indicator recognizing unit 21 determines whether the indication point of the indicator 4 has moved from the section 2 to the section 3 (step S14).

Namely, in step S14, it is determined whether the indication point of the indicator 4 has moved from the selectable space to the selection fixation space. In the selectable space, a desired object is selected by the indication point of the indicator 4. When the indication point of the indicator 4 moves from the selectable space to the selection fixation space (“YES” in step S14), the selected object is fixed (step S15).

As a result of the foregoing, an object to be operated is specified. When the indication point of the indicator 4 was also located in the selection fixation space in the previous state (“NO” in step S14), the indicator recognizing unit 21 recognizes the shape of the indicator 4 (step S15-2). The indicator recognizing unit 21 recognizes whether the shape of the indicator is a predefined shape (step S16). Whether the shape of the indicator 4 is unclear can be determined on the basis of whether an operation assigned to the shape of the indicator 4 can be specified.

Respective operations performed on an object to be operated have been assigned to the shapes of the indicator 4, or the combinations of the shape and the motion of the indicator 4. Therefore, when the operation specifying unit 23 fails to specify an operation on the basis of the shape of the indicator 4 recognized by the indicator recognizing unit 21, it is determined that the shape of the indicator 4 is unclear. As an example, the operation specifying unit 23 fails to specify the operation on the basis of the shape of the indicator 4 at a stage at which the indicator 4 is being changed from the first shape to the second shape.

The operation specifying unit 23 determines whether a state in which the operation fails to be specified continues longer than a prescribed time period (step S16-2). When the state in which the operation fails to be specified does not continue longer than the prescribed time period, the process moves on to step S15-2. When the state in which the operation fails to be specified continues longer than the prescribed time period, the process moves on to “C”.

The indicator recognizing unit 21 then determines whether the recognized shape of the indicator 4 is the first shape (step S16-3). When the recognized shape of the indicator 4 is the first shape (“YES” in step S16-3), the process moves on to step S18-2.

Meanwhile, the operation specifying unit 23 specifies the operation on the basis of the shape or the combination of the shape and the motion of the indicator 4 that the indicator recognizing unit 21 has recognized. Then, the range changing unit 24 sets an operable space that corresponds to the operation specified by the operation specifying unit 23 (step S17). As described above, some operations are performed by using a wide operable space, as illustrated in FIG. 9, and it is preferable for other operations that the operable space be set so as to be narrow. Therefore, the range changing unit 24 changes the operable space so as to be within a range that corresponds to the operation.

Then, the indicator recognizing unit 21 sets the indication point at a gravity center position of the indicator 4 (step S18). For the selection shape, the indication point is set at a fingertip in order to select an object. On the other hand, for the operation shape, the indicator 4 varies into various shapes. As an example, the fourth shape illustrated as an example in FIG. 7 has a shape in which fingers are bent.

Therefore, for the operation shape, the indicator recognizing unit 21 sets the indication point at the gravity center position of the indicator 4. This allows the indicator recognizing unit 21 to stably recognize the indication point even if the indicator 4 is changed into any shape.

Then, an operation that has been associated with the shape of the indicator 4 on the basis of the position of the indication point is performed (step S18-2). The indicator recognizing unit 21 determines whether the indicator 4 has moved outside the operable region from the operable space (step S19). When the indicator recognizing unit 21 determines that the indicator 4 has not moved from the operable space (“NO” in step S19), the process moves on to “E”.

When the indicator recognizing unit 21 recognizes that the indicator 4 has moved outside the operable region from the operable space (“YES” in step S19), the indicator recognizing unit 21 re-recognizes the indicator 4, and determines whether the indicator 4 has moved from the outside of the operable region to the section 3, and whether the indicator 4 has a final shape (step S20).

When the indicator 4 returns in the same shape as a shape at the time of moving outside the operable space (final shape) after the indicator 4 moves outside the section 3 (operable space) (“YES” in step S20), the process returns to step S18-2. In this case, an operation assigned to the final shape of the indicator 4 is validated. On the other hand, when the decision in step S20 is “NO”, the object for which the selection has been fixed is deselected (step S21), and the process moves on to “C”. Namely, the process moves on to step S1 in the flowchart of FIG. 11.

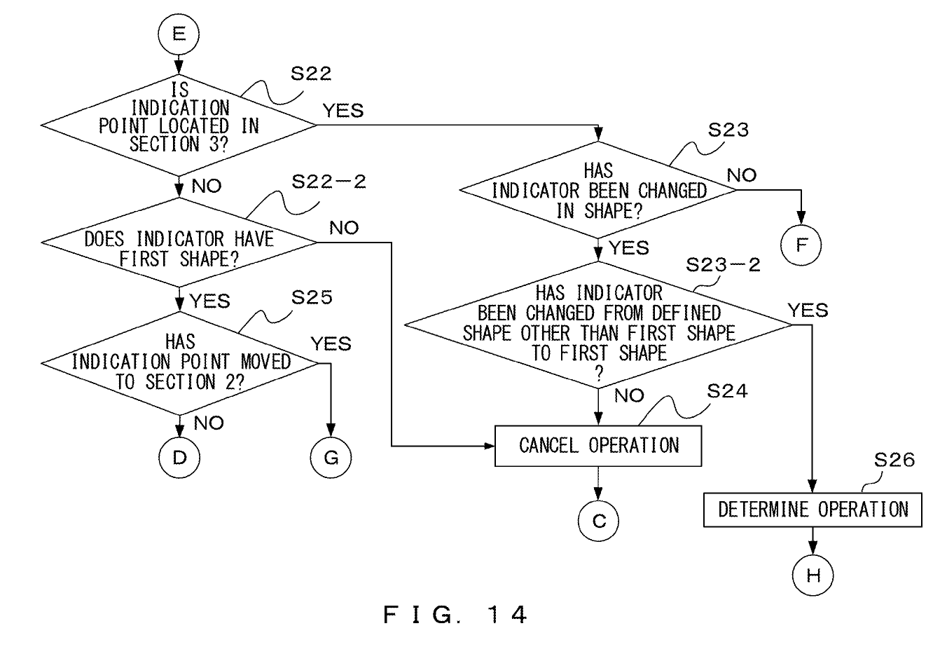

The process of “E” that follows step S20 is described next with reference to the flowchart of FIG. 14. The indicator recognizing unit 21 determines whether the indication point of the indicator 4 is located in the section 3 (step S22). Namely, it is determined whether the indication point of the indicator 4 is continuously located in the operable space.

When it is determined that the indication point of the indicator 4 is located in the section 3 (“YES” in step S22), the indicator recognizing unit 21 determines whether the shape of the indicator 4 has been changed (step S23).

When the indicator recognizing unit 21 determines that the shape of the indicator 4 has not been changed (“NO” in step S23), the process moves on to step S18-2 of FIG. 13 through “F”. Namely, the operation assigned to the shape or the combination of the shape and the motion of the indicator 4 continues to be performed.

On the other hand, when the indicator recognizing unit 21 determines that the shape of the indicator 4 has been changed (“YES” in step S23), the indicator recognizing unit 21 determines whether the shape of indicator has been changed from a defined shape other than the first shape to the first shape (step S23-2). When the shape of the indicator 4 is changed from the defined shape other than the first shape to the first shape (“YES” in step S23-2), the operation is decided (step S26). Then, the process moves on to step S15-2 through “H”.

In a case of another change in shape, the operation is canceled (step S24). When the shape of the indicator 4 is changed, the operation is also changed. Therefore, when it is recognized that the shape of the indicator 4 has been changed, the operation is canceled.

When the indicator recognizing unit 21 determines that the indication point of the indicator 4 is not located in the section 3 (“NO” in step S22), the indicator recognizing unit 21 determines whether the shape of the indicator 4 is the first shape (step S22-2). When it is recognized that the shape of the indicator 4 is the first shape, it is determined whether the indication point has moved to the section 2 (step S25).

When it is determined that the indication point has moved to the section 2 (“YES” in step S25), the indication point moves to the selectable space, and reselection can be performed. Therefore, the process moves onto step S9 through “G”, and an object can be selected. When the decision in step S22-2 is “NO”, the indication point has moved outside the operable space. Therefore, the process moves on to step S24, and decided operation is canceled.

On the other hand, when the indication point of the indicator 4 has not moved to the section 2 (“NO” in step S25), the shape of the indicator is the first shape, and the indication point is not located in the section 3, and has not moved to the section 2. In this case, the indicator 4 is located in the section 4, and the process moves on to “D”. Namely, the process of step S27 described later is performed.

In step S13 of FIG. 13, when it is determined that the indication point of the indicator 4 is not located in the section 3 (“NO” in step S13), the process moves on to “D”. When the decision in step S13 is “NO”, the indication point of the indicator 4 is not located in the section 1, the section 2, or the section 3.

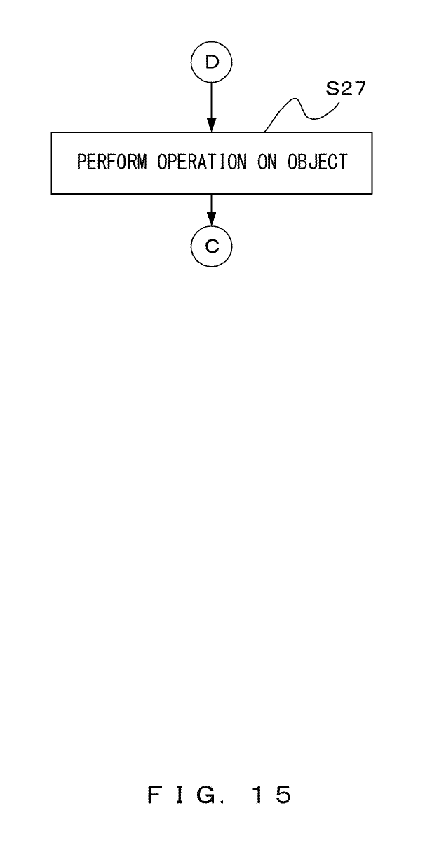

In this case, the indication point of the indicator 4 is located in the section 4. When the indication point of the indicator 4 is located in the section 4, the decided operation to be performed on an object is performed in step S27, as illustrated in the example of FIG. 15 (step S27). Then, the process moves on to step S1 through “C”.

As a result of the foregoing, an object is selected, and an operation is performed on the selected object. Processes of selecting an object and of performing an operation on the selected object are not limited to the examples of the flowcharts illustrated in FIG. 11 through FIG. 15.

### <Example of Object Selection>

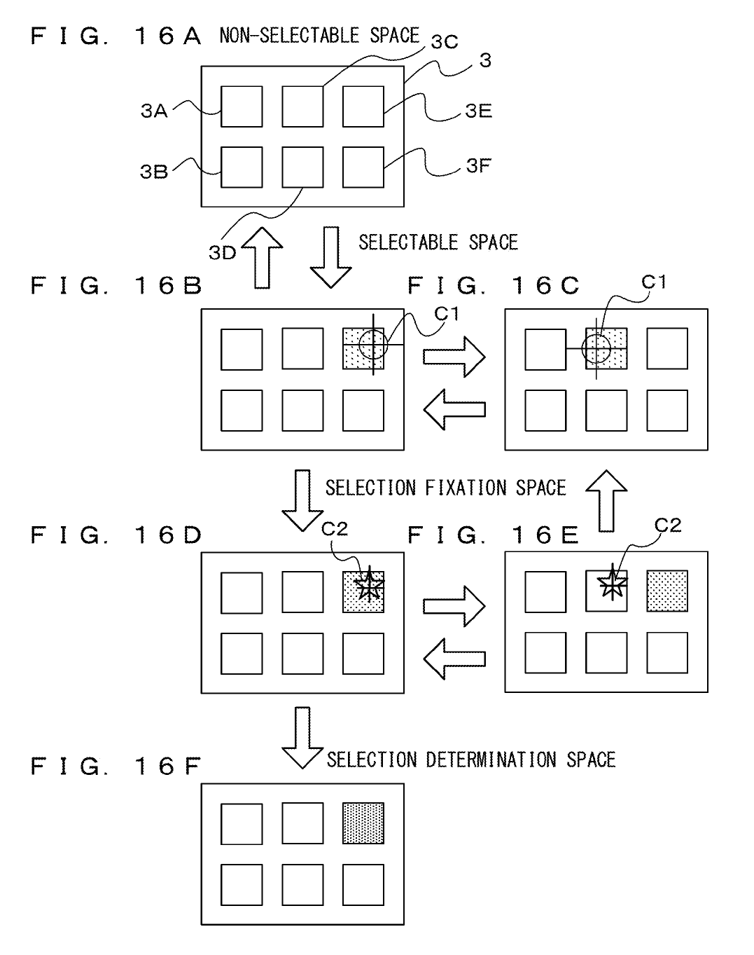

An example of selection of an object displayed on the display surface 3 is described next with reference to FIG. 16. When the indicator 4 is located in the non-selectable space that is the farthest space with respect to the display surface 3, the display control unit 25 does not change a display of the objects 3A-3F. The example is illustrated as FIG. 16A in FIG.

In the embodiment, the display control unit 25 displays a cursor at the position at which the indication point of the indicator 4 that the indicator recognizing unit 21 has recognized is projected on the display surface. Note that the display control unit 25 may display an item other than the cursor if the projected position of the indication point on the display surface 3 can be recognized. In the example of FIG. 16, when the indicator recognizing unit 21 recognizes that the indicator 4 is located in the selectable space, the display control unit 25 displays a first cursor C1 on the display surface 3.

The example of FIG. 16B illustrates a state in which the first cursor C1 overlaps the object 3E. In this case, the display control unit 25 highlights the object 3E. When the indicator 4 is located in the selectable space, the selection of an object is not decided.

When the indicator recognizing unit 21 recognizes that the position of the indicator 4 has moved, another object is selected. The example of FIG. 16C illustrates a case in which the indicator 4 selects the object 3C. An arbitrary object can be selected from among the objects 3A-3F by moving the indicator 4 in the horizontal direction.

When the indicator recognizing unit 21 recognizes that the indicator 4 has moved from the selectable space to the selection fixation space, the display control unit 25 displays a second cursor C2. The second cursor C2 is displayed at the position at which the position of the indicator 4 in the three-dimensional space is projected on the display surface 3.

In the example of FIG. 16, the display control unit 25 displays the first cursor C1 and the second cursor C2 in different forms. As a result, it is clearly distinguished whether a cursor displayed on the display surface 3 is the first cursor C1 in a case in which the indicator 4 is located in the selectable space, or the second cursor C2 in a case in which the indicator 4 is located in the selection fixation space.

In the example of FIG. 16D, it is assumed that the indicator 4 has moved from the selectable space to the selection fixation space while selecting the object 3E. Namely, the selection of the object 3E is fixed. Therefore, even when the second cursor C2 moves in the horizontal direction as a result of the movement of the indicator 4, as illustrated in FIG. 16E, the selection of the object 3E has been fixed. The display control unit 25 highlights the object 3E for which the selection has been fixed.

FIG. 16F illustrates an example of a case in which the indicator 4 has moved to the selection decision space. When the indicator 4 moves from the selection fixation space to the selection decision space, the selection of the object 3E is decided. The display control unit 25 highlights the object 3E for which the selection has been decided.

The display control unit 25 changes a state of the highlighting of an object in accordance with cases in which the indicator 4 is located in the selectable space, the selection fixation space, and the selection decision space. It is clarified which space the indicator 4 is located in by changing the highlighting of the object for respective spaces.

<Example of a Case in which the Operable Space is Expanded to the Maximum>

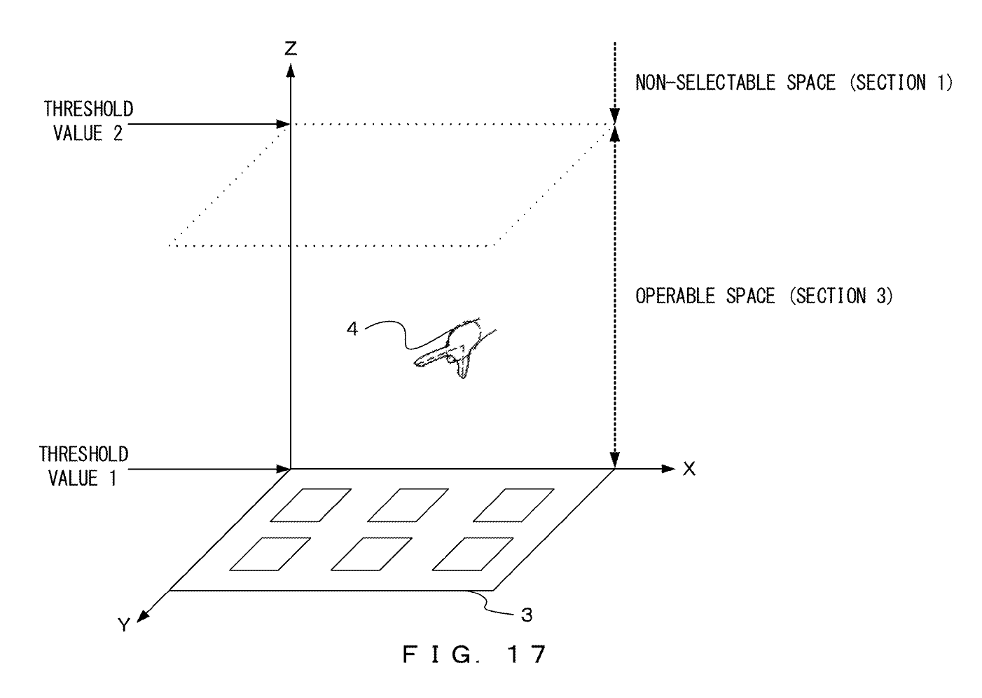

FIG. 17 illustrates an example in which the operable space is expanded to the maximum. In the example of FIG. 17, a Z-axis coordinate of a threshold value 1 is the same as that of the display surface 3. A Z-axis coordinate of a threshold value 2 is the same as that of a threshold value 3.

As a result, a wide space between the non-selectable space and the display surface 3 can be set to be an operable space. As an example, when an operation with a large motion range in the horizontal direction and the vertical direction is performed, a dynamic motion can be performed by expanding the operable space to the maximum.

### <Examples of Three-Dimensional Models of a Recognizable Space and an Operable Space>

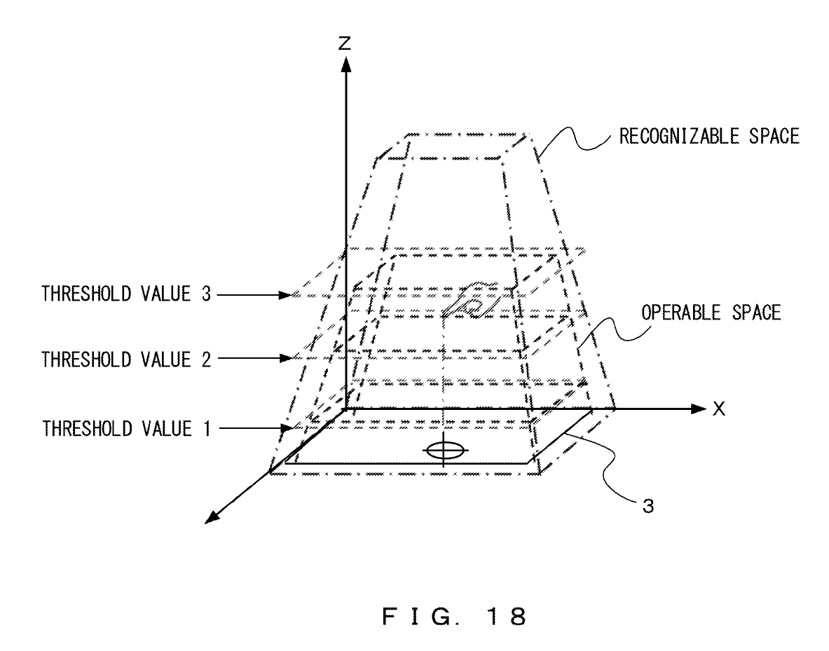

FIG. 18 illustrates examples of three-dimensional models of a recognizable space and an operable space. The recognizable space indicates a space that can be recognized by the sensor 5 (the sensor 5 and the sensor 6 when a stereo sensor is used). The operable space is a space smaller than the recognizable space.

### Concrete Examples

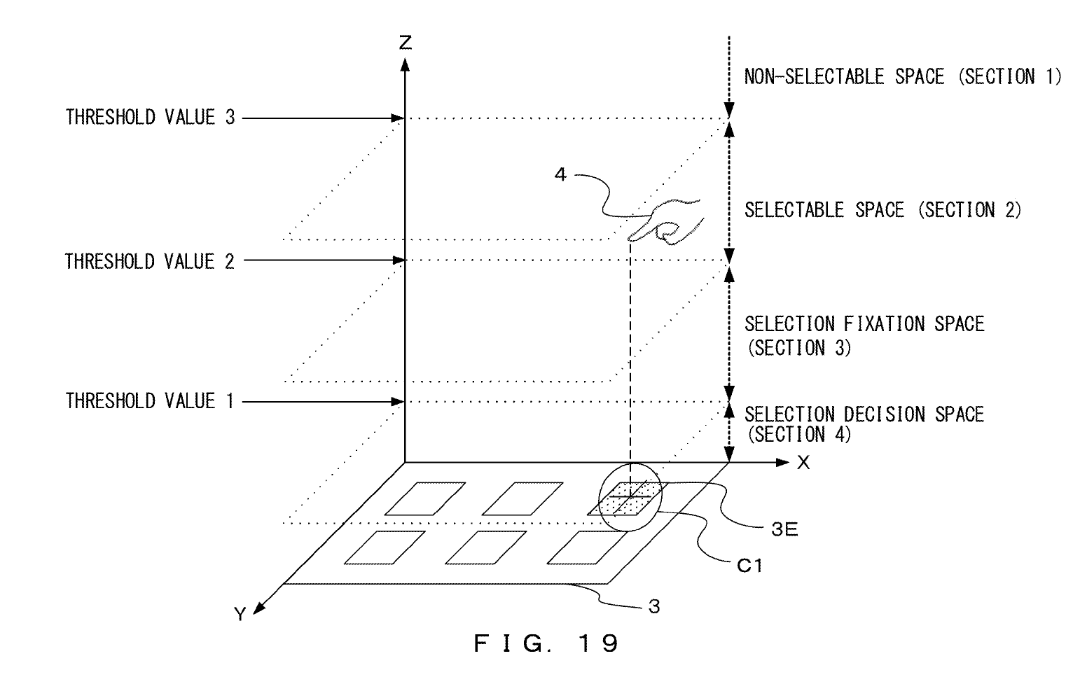

Concrete examples are described next. FIG. 19 illustrates an example in which the indicator 4 is located in the selectable space in the selection shape (first shape). A position at which the indication point of the indicator 4 is projected on the display surface 3 overlaps the object 3E. Accordingly, the object 3E is highlighted.

In the embodiment, the first cursor C1 is a symbol formed by combining a circle and a cross. In the embodiment, a size of the first cursor C1 is changed in accordance with a position with respect to the display surface 3. In the example of FIG. 19, the indication point of the indicator 4 is located in a position that is far from the display surface 3 in the selectable space. Therefore, a circle of the first cursor C1 is large.

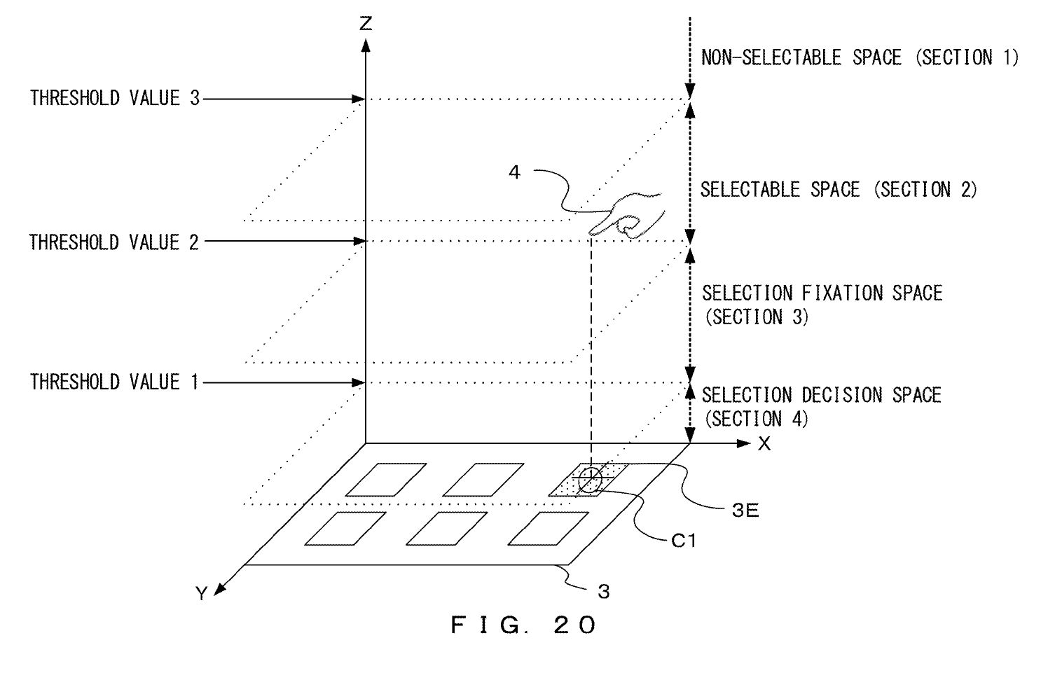

FIG. 20 illustrates a case in which the indicator 4 has moved closer to the display surface 3 in the selectable space. In this case, the display control unit 25 displays the circle of the first cursor C1 so as to be small. As a result, a distance relationship between the indication point of the indicator 4 in the selectable space and the display surface 3 can be displayed recognizably.

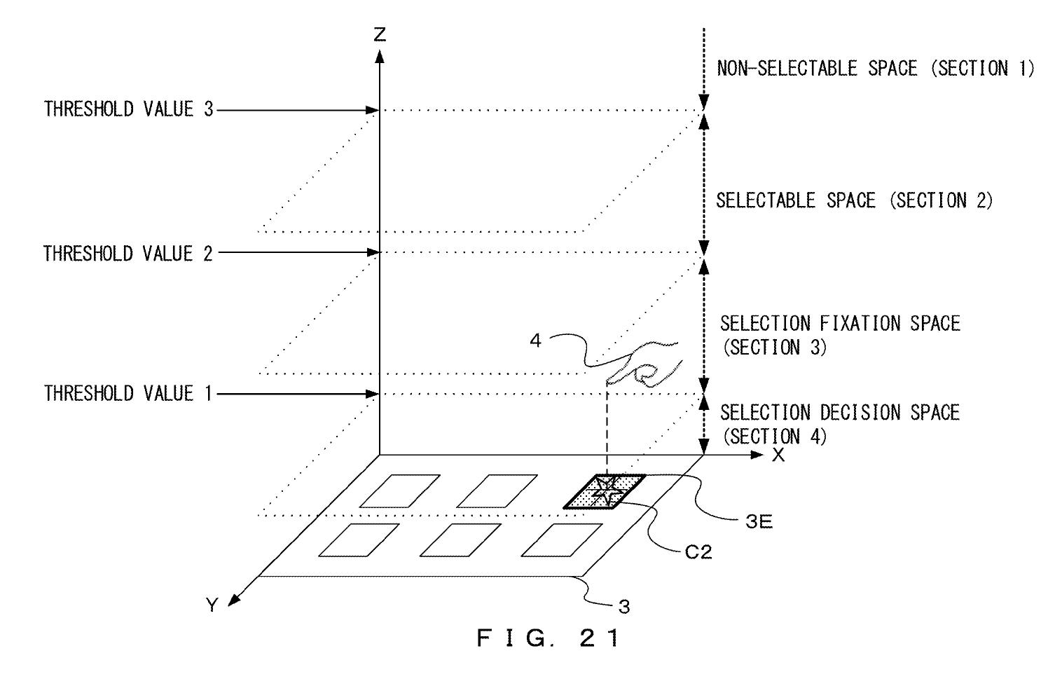

FIG. 21 illustrates an example of a case in which the indicator 4 has moved from the selectable space to the selection fixation space. The indicator recognizing unit 21 recognizes that the indication point of the indicator 4 is located in the selection fixation space. Therefore, the display control unit 25 highlights the object 3E. The display control unit 25 also displays the second cursor C2 in a position of the indication point of the indicator 4 on the display surface 3. As a result, the selection of the object 3E is fixed.

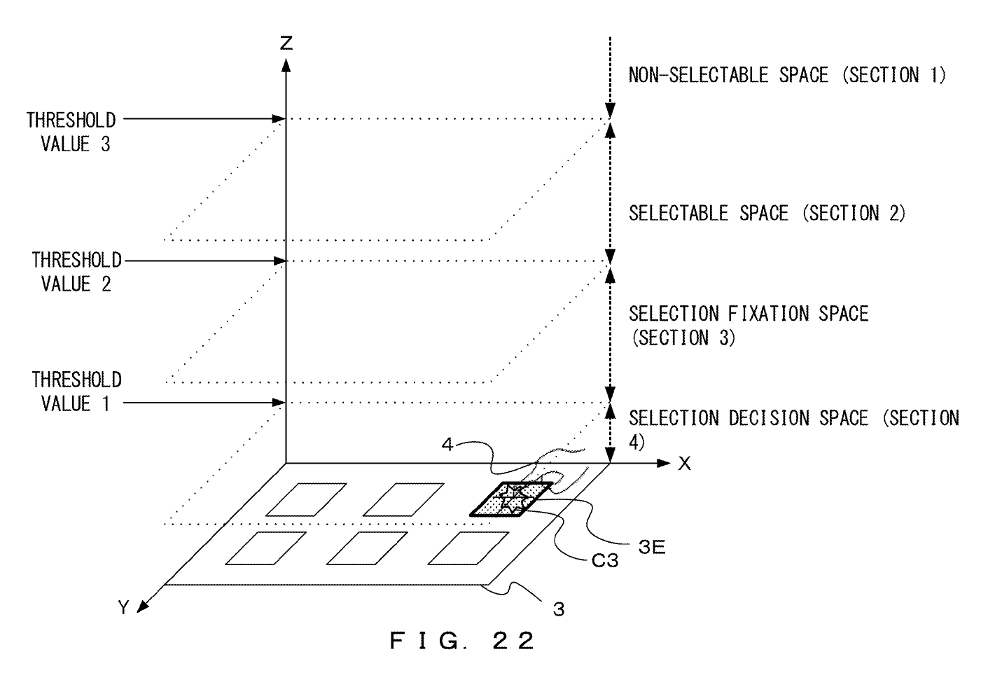

FIG. 22 illustrates an example of a case in which the indicator 4 has moved from the selection fixation space to the selection decision space. The indicator recognizing unit 21 recognizes that the indication point of the indicator 4 is located in the selection decision space. Therefore, the display control unit 25 highlights the object 3E for which the selection has been fixed. The display control unit 25 also displays a third cursor C3 in a position of the indication point of the indicator 4 on the display surface.

The third cursor C3 is a cursor indicating that the indicator 4 is located in the selection decision space. The third cursor C3 is displayed differently from the first cursor C1 and the second cursor C2. This clarifies that the indicator 4 is located in the selection decision space. When the indicator 4 has moved from the selection fixation space to the selection decision space, the selection of the object 3E is determined, and a function assigned to the object 3E is performed.

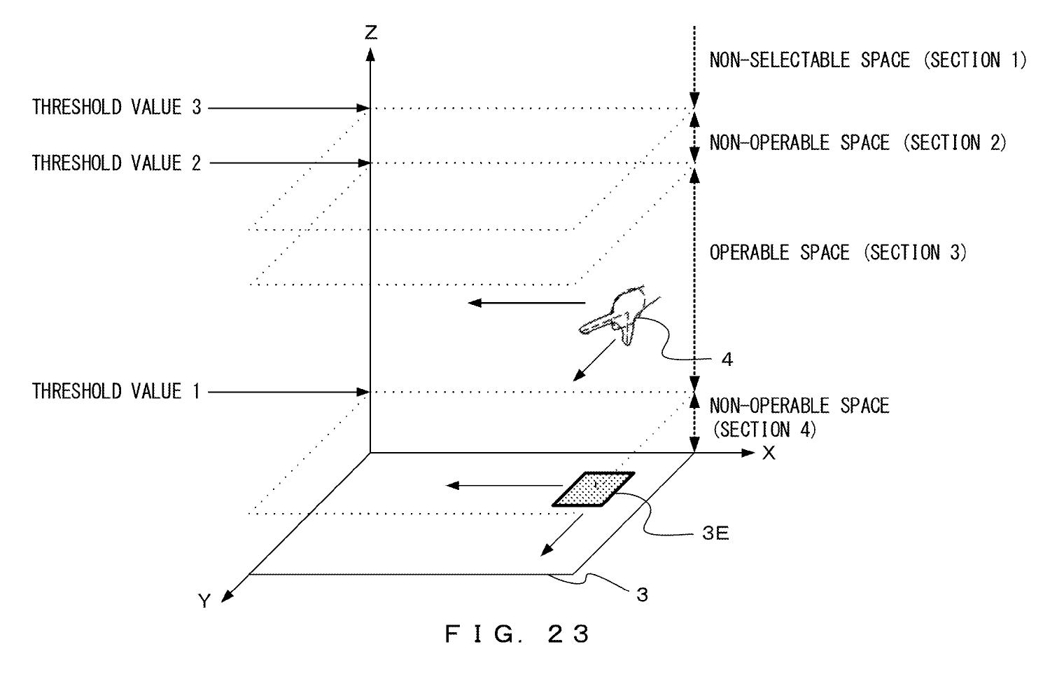

FIG. 23 illustrates an example of an operation of moving the object 3E in the horizontal direction. When an operation is performed on the object 3E, the shape of the indicator 4 is changed from the first shape in the selection fixation space (section 3). In the example of FIG. 23, the shape of the indicator 4 is changed to the second shape.

The indicator recognizing unit 21 recognizes that the shape of the indicator 4 has changed from the first shape to the second shape. As a result, the range changing unit 24 increases or reduces a size of the operable space (section 3) in accordance with the operation in the second shape. In the example of FIG. 23, the operable space is enlarged.

When the shape of the indicator 4 is the second shape, and the indicator 4 moves in the horizontal direction, the object 3E moves in the horizontal direction. When the shape of the indicator 4 is the third shape, and the indicator 4 moves in the vertical direction, the object 3E is enlarged or reduced.

Accordingly, when the indicator recognizing unit 21 recognizes that the shape of the indicator 4 has been changed to the second shape, the range changing unit 24 enlarges the operable space in order to secure a space that is sufficient for the indicator 4 to perform a motion in the vertical direction.

When the operation specifying unit 23 recognizes that the shape of the indicator 4 is the second shape and that the indicator 4 has moved in the horizontal direction, the operation specifying unit 23 moves the object 3E in the horizontal direction. As a result, the display control unit 25 moves the object 3E on the display surface 3 in accordance with the movement of the indicator 4.

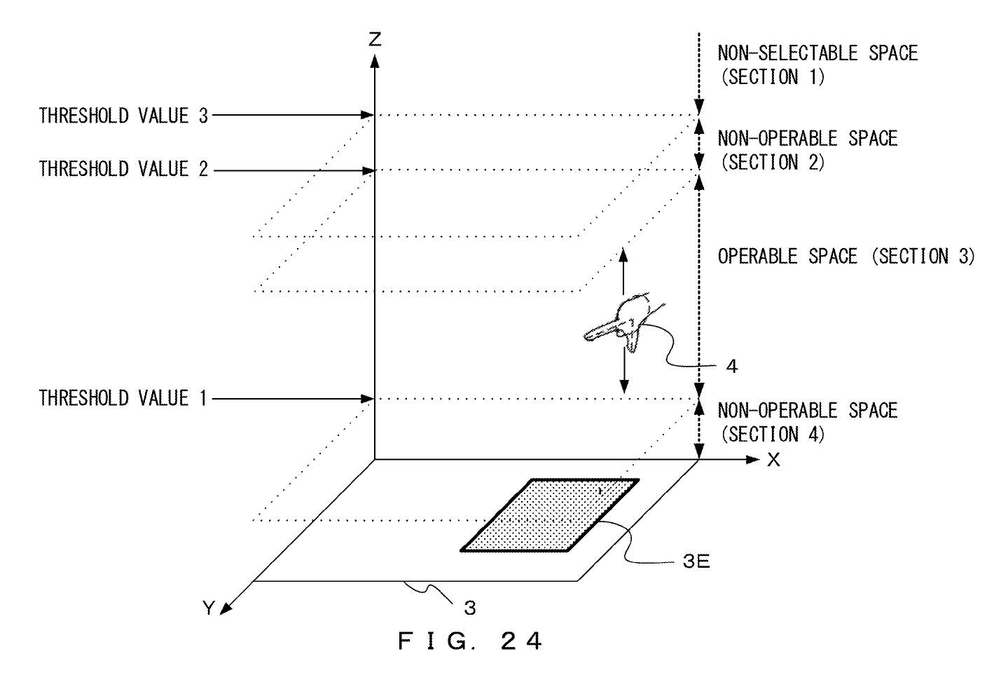

FIG. 24 illustrates an example of an operation of enlarging the object 3E. The indicator recognizing unit 21 recognizes that the shape of the indicator 4 is the second shape and that the indicator 4 has moved in the vertical direction. As a result, the operation specifying unit 23 specifies an operation of enlarging or reducing the object 3E.

When the indicator 4 moves in the vertical direction, the operation of enlarging or reducing the object 3E is performed. The operable space has been expanded in accordance with the operation assigned to the second shape of the indicator 4, and therefore a sufficient space for the operation of enlarging or reducing the object 3E can be secured.

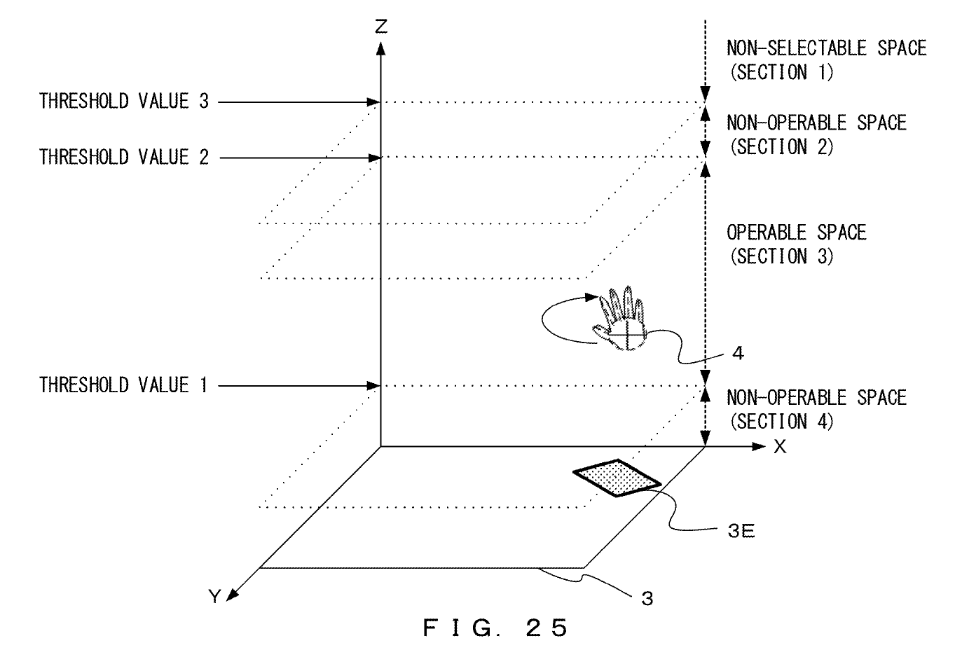

FIG. 25 illustrates an example of an operation of rotating the object 3E. When the indicator recognizing unit 21 recognizes that the shape of the indicator 4 is the fifth shape and that the indicator 4 has rotated on the horizontal plane, the display control unit 25 rotates the object 3E displayed on the display surface 3.

As an example, when the indicator 4 in the fifth shape rotates on the horizontal plane with high speed, the indicator recognizing unit 21 may recognize the rotation, and the display control unit 25 may rotate the object 3E displayed on the display surface 3 with high speed.

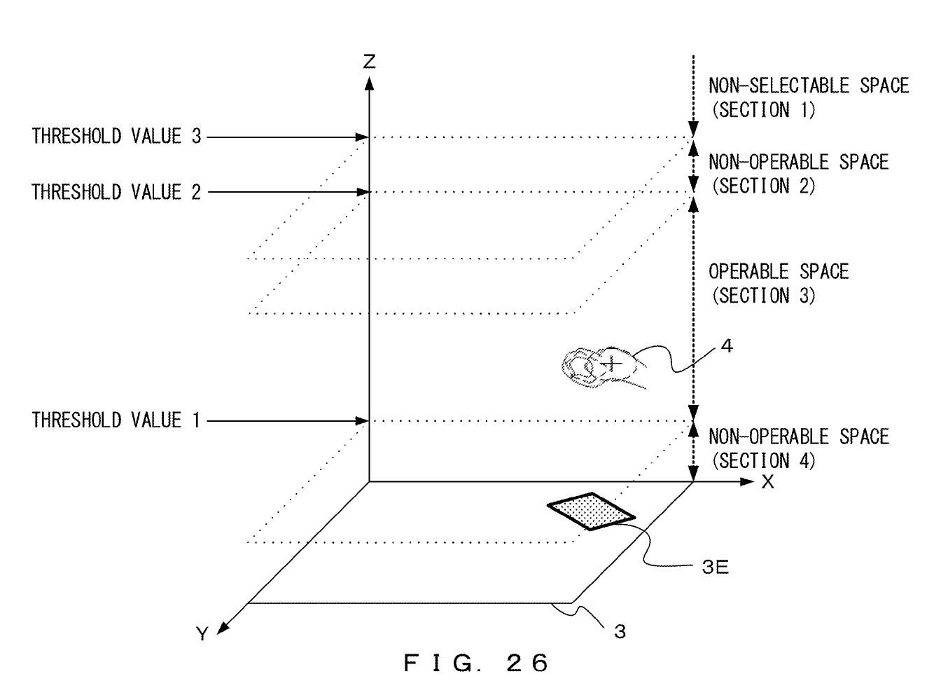

When the various operations described above are performed, the operation is finally decided. In the examples of the flowcharts described above, when operations are changed in accordance with the shapes of the indicator 4, the indicator recognizing unit 21 recognizes the change, and the operation is decided. FIG. 26 illustrates the example thereof. An operation of deciding an operation performed on the object 3E can be assigned to the shape of the indicator 4. As an example, as illustrated in the example of FIG. 26, when the indicator recognizing unit 21 recognizes that the indicator 4 has been changed to have the sixth shape, the operation may be decided. As a result, a rotating operation performed on the object 3E is decided.

Alternatively, an operation may be decided when the indication point of the indicator 4 moves to the section 4. An operation of deciding an operation performed on the object 3E can be assigned to the shape of the indicator 4.

As described above, the range changing unit 24 can secure a three-dimensional space suitable for the type of operation by changing an operable space in accordance with an operation assigned to a shape, or a combination of a shape and a motion of the indicator 4. As a result, various input operations can be realized.

In addition, the indication point of the indicator 4 is not decided when the indication point is located in the selectable space. When the indication point of the indicator 4 selects an object in the selectable space, and the selection of the object is fixed in the selection fixation space, the object is selected. Therefore, an object can be selected in an accurate indication position.

### First Application Example

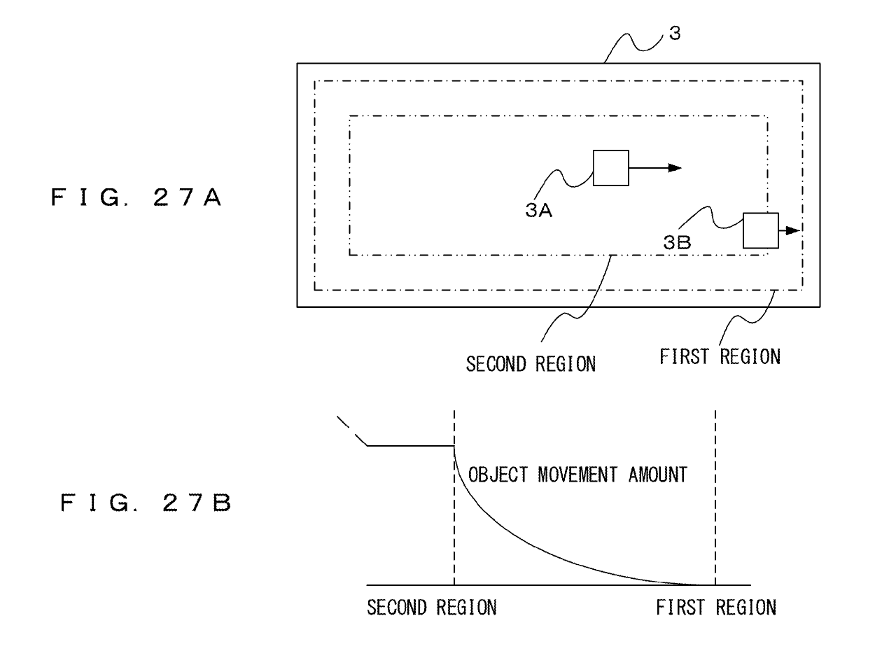

The first application example is described next with reference to FIG. 27. FIG. 27A illustrates examples of the objects 3A and 3B displayed on the display surface 3. FIG. 27 also illustrates a first region and a second region. Information indicating the first region and the second region is not displayed on the display surface 3. However, the information may be displayed. The second region is smaller than the first region.

The first region is a space in which the indicator 4 can operate an object. An operation is not performed by the indicator 4 in a region outside the first region. The second region is set so as to be smaller than the first region. Within the second region, an object can be operated by the indicator 4.

The first application example illustrates an example in which an operation of moving the object 3A and the object 3B is performed. Accordingly, the shape of the indicator 4 is the second shape. A user moves the selected object 3A or 3B while maintaining the indicator 4 in the second shape.

An object within the second region moves by a movement amount suitable for a movement amount of the indicator 4 that the indicator recognizing unit 21 recognizes. Namely, within the second region, an object moves on the display surface 3 with a speed that corresponds to a moving speed of the indicator 4.

On the other hand, when the object moves to a region between the second region and the first region, the movement amount of the object is sequentially reduced with respect to the movement amount of the indicator 4. When the object reaches a boundary of the first region, the object is inoperable.

Therefore, the object 3B in FIG. 27A moves at a speed lower that the moving speed of the indicator 4. The moving speed of the object 3B is sequentially reduced, and when the object 3B reaches the first region, the object 3B is inoperable.

FIG. 27B illustrates an example of an object movement amount in the region between the first region and the second region. Before an object reaches a boundary of the second region, the object moves at a speed suitable for the moving speed of the indicator 4. When the object moves across the boundary of the second region, the movement amount is sequentially reduced. When the object reaches the first region, the movement amount becomes zero.

As described above, when the object moves outside the second region, the movement mount of the object is sequentially reduced with respect to the movement amount of the indicator 4, and therefore a user can recognize that the object is approaching a boundary of an operable region, on the basis of a reduction in the movement amount. Namely, the user can recognize the operable region on the basis of the movement amount of the object.

### Second Application Example

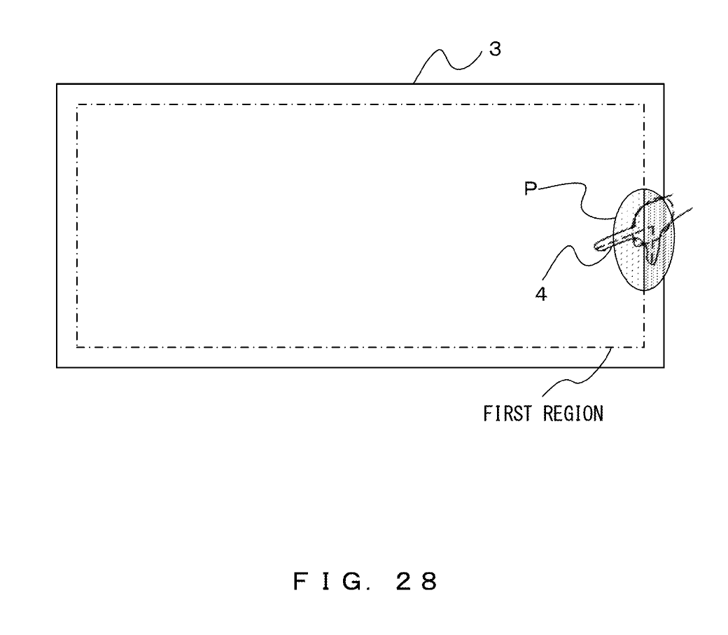

The second application example is described next with reference to FIG. 28. FIG. 28 illustrates a case in which the indicator 4 is located at the boundary of the first region. In other words, the indicator 4 is located at the boundary of the operable region. Also in the second application example, it is assumed that an operation is performed on an object. Accordingly, the shape of the indicator 4 is the operation shape.

The indicator recognizing unit 21 recognizes a position of the indicator 4. The boundary display unit 27 controls the projector 2 so as to project an image indicating the boundary at a position that the indicator recognizing unit 21 has recognized. In the example of FIG. 28, the projector 2 projects an elliptical image P to the indicator 4.

FIG. 28 illustrates an example in which the projector 2 projects the elliptical image P having different colors between portions inside and outside the first region. As a result, the boundary of the first region can be recognized.

The example of FIG. 28 illustrates an example in which the image P is elliptical, but the shape of the image P is not limited to an ellipse. As an example, the projected image P may be circular, square or the like. In addition, in the example of FIG. 28, an example has been described in which the image P has different colors between the portions inside and outside the first region, but the portions may be set such that one portion flickers and the other portion does not flicker.

In the example of FIG. 28, the image P has different display states between the portions inside and outside the first region, but the display states may be the same. In this case, the boundary of the first region is not clearly illustrated, but a user can recognize that the indicator 4 is located near the boundary of the operable region.

### Third Application Example

The third application example is described next. Also in the third application example, it is assumed that the shape of the indicator 4 is the operation shape. When the indicator recognizing unit 21 recognizes that the indicator 4 is located at the boundary of the first region, the indicator recognizing unit 21 reports it to the speaker control unit 28. In reply to the report, the speaker control unit 28 controls the speaker 19 so as to generate sound. As a result, a user can recognize that the indicator 4 is located at the boundary of the operable region.

### Fourth Application Example

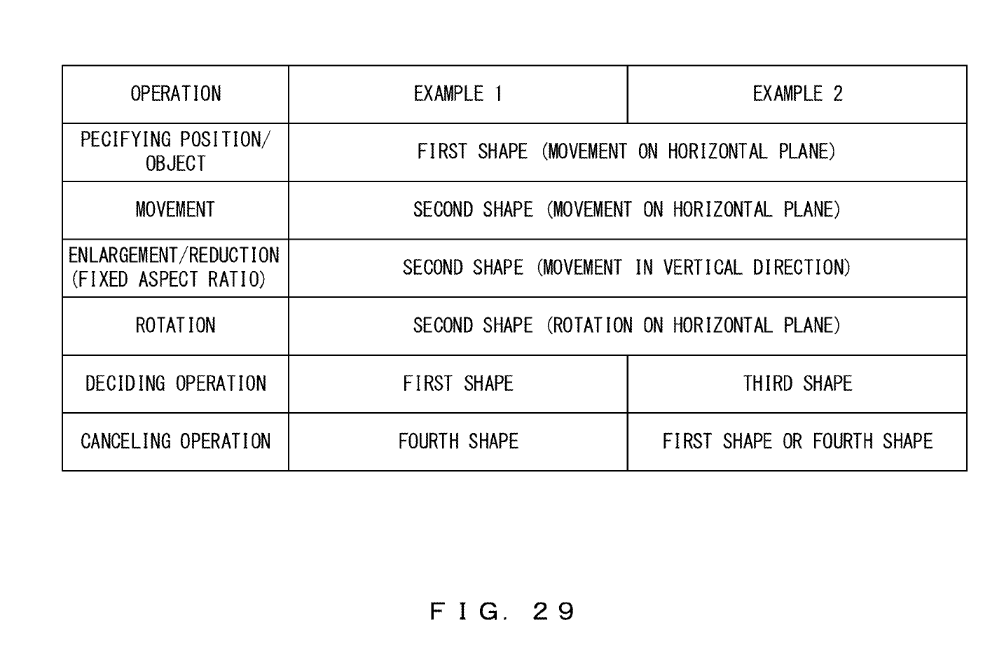

The fourth application example is described next with reference to FIG. 29. FIG. 29 illustrates examples of operations assigned to the shapes and the motions of the indicator 4. The selection shape for selecting an object is the first shape. The operation shape for operating the selected object includes the second through fourth shapes.

A moving operation, an enlarging or reducing operation, and a rotating operation performed on an object are assigned to the second shape. These three operations are distinguished in accordance with a motion of the indicator 4 when the indicator 4 is in the second shape.

When the indicator recognizing unit 21 recognizes that the indicator 4 has moved on the horizontal plane while maintaining the second shape, the operation specifying unit specifies that the object moving operation has been performed. When the indicator recognizing unit 21 recognizes that the indicator 4 has moved in the vertical direction while maintaining the second shape, the operation specifying unit 23 specifies that the object enlarging or reducing operation has been performed. When the indicator recognizing unit 21 recognizes that the indicator 4 has rotated on the horizontal plane while maintaining the second shape, the operation specifying unit 23 specifies that the object rotating operation has been performed.

In example 1, when the indicator recognizing unit 21 recognizes that the shape of the indicator 4 has been changed to the first shape, the operation specifying unit 23 specifies that an operation determining operation has been performed. When the indicator recognizing unit 21 recognizes that the shape of the indicator 4 has been changed to the fourth shape, the operation specifying unit 23 specifies that an operation canceling operation has been performed.

As described above, as the operation shape, different shapes of the indicator 4 may be respectively assigned to various operations performed on an object, the operation determining operation, and the operation cancelling operation. As a result, the various operations (the above three operations) can be performed on the object when the indicator 4 is in the same shape. Therefore, the shape of the indicator can be maintained even when different operations are performed on the object.

### Fifth Application Example

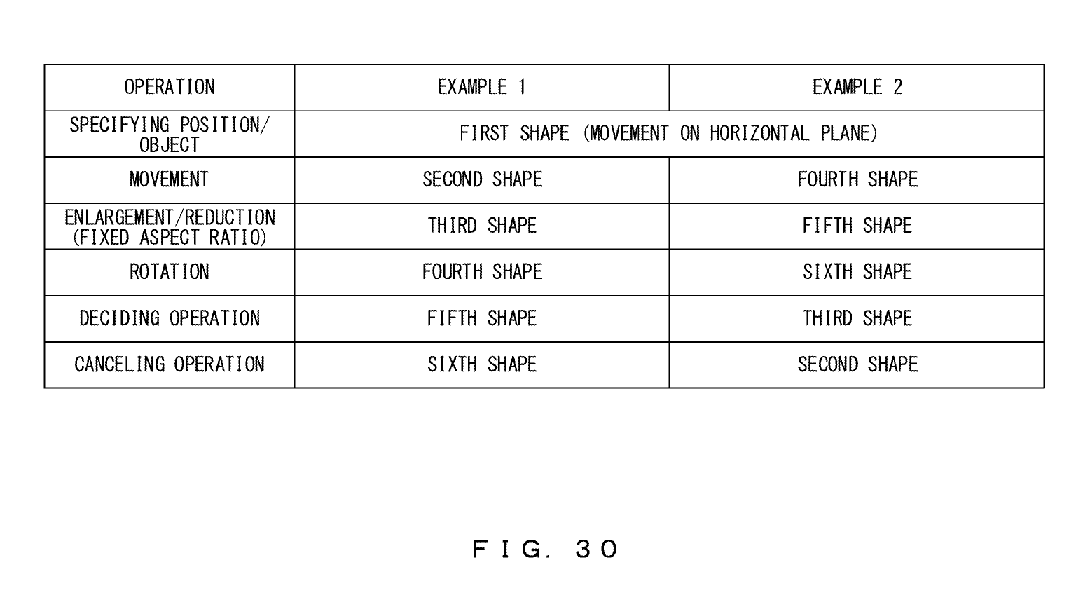

The fifth application example is described next with reference to FIG. 30. FIG. 30 illustrates examples of operations assigned to the shapes of the indicator 4. The selection shape for selecting an object is the first shape. The operation shape for operating the selected object includes the second through sixth shape.

In the fifth application example, operations are assigned to respective shapes of the indicator 4. In the example of FIG. 10 or FIG. 29, operations are assigned to respective combinations of the shape and the motion of the indicator 4, but operations may be assigned to respective shapes of the indicator 4.

As an example, in example 1, the second shape is assigned to an operation of moving an object. The third shape is assigned to an operation of enlarging or reducing an object. The fourth shape is assigned to an operation of rotating an object. The fifth shape is assigned to the operation deciding operation. The sixth shape is assigned to the operation canceling operation.

In the fifth application example, operations are assigned to the respective shapes of the indicator 4, and therefore a user can simply recognize a correspondence relationship between the operation and the shape of the indicator 4. Accordingly, operations may be assigned to respective combination of the shape and the motion of the indicator 4, as in the fourth application example, or may be assigned to respective shapes of the indicator 4, as in the fifth application example.

### Sixth Application Example

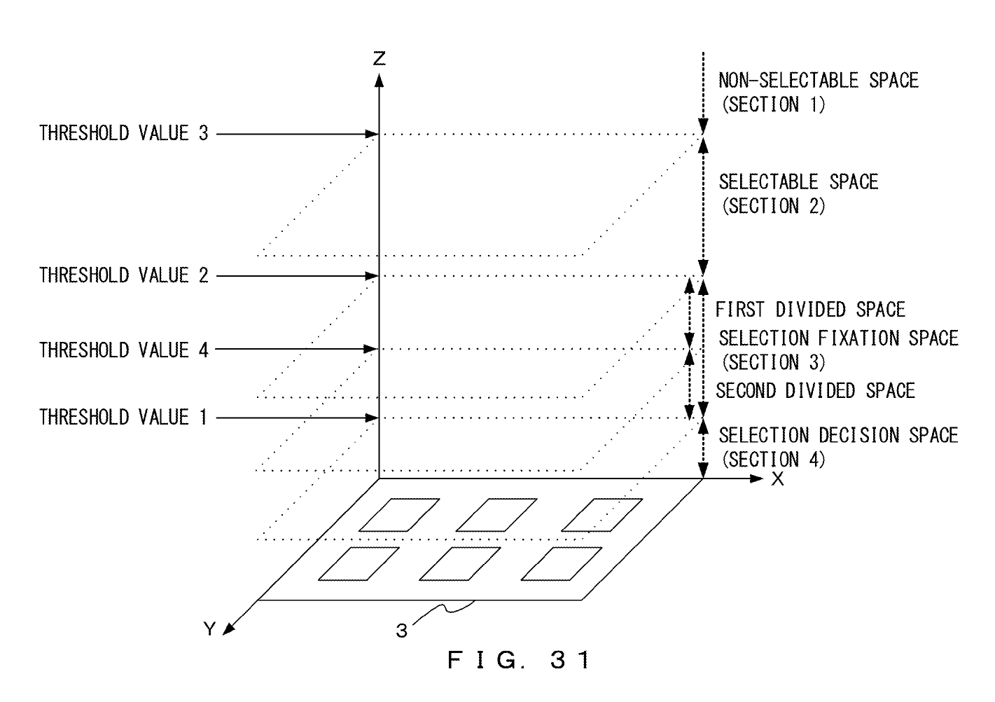

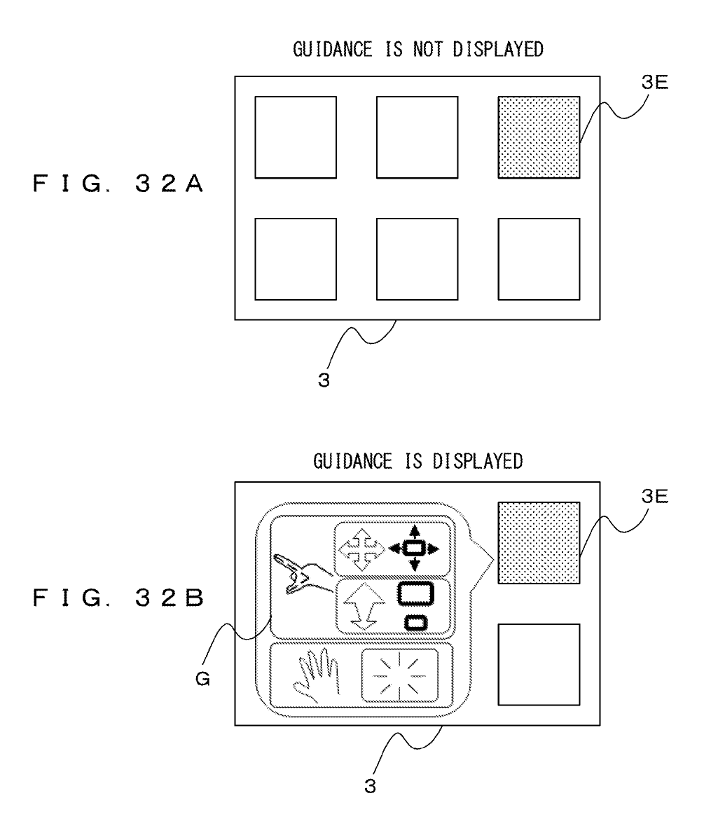

The sixth application example is described next with reference to FIG. 31 and FIG. 32. In the example of FIG. 31, the selection fixation space (section 3) is divided in the vertical direction into two spaces. A divided space that is close to the selectable space is assumed to be a first divided space, and a divided space that is close to the selection decision space is assumed to be a second divided space.

The example of FIG. 31 illustrates an example in which the selection fixation space is divided into two halves, but the first divided space and the second divided space may have different sizes. A threshold value in the Z-axis direction when dividing the selection fixation space is assumed to be a fourth threshold value.

In the selection fixation space, an object selected in the selectable space is fixed. Namely, when the indicator 4 moves to the selection decision space, the selection of the object for which the selection has been fixed is determined. Alternatively, when the shape of the indicator 4 is changed from the selection shape to the operation shape, a prescribed operation is performed on the object for which the selection has been fixed.

In this case, when a user fails to recognize the shape of the indicator 4 assigned to an operation that the user desires to perform, it is preferable to display a guidance. FIG. 32A illustrates a case in which a guidance G is not displayed on the display surface 3, and FIG. 32B illustrates a case in which the guidance G is displayed on the display surface 3.

The shapes of the indicator 4 assigned to operations can be visually presented to a user who is not used to the operations by displaying the guidance G on the display surface 3. The user who is not used to the operations visually recognizes information displayed in the guidance G, and changes the indicator 4 so as to have a shape assigned to a desired operation. On the other hand, it is preferable that the guidance G is not displayed for a user who is used to the operations. In this case, visibility is reduced because the guidance G is always displayed on the display surface 3.

In view of the foregoing, when the shape of the indicator 4 does not vary during a prescribed time period after the indicator 4 moves from the selectable space to the first divided space, or when the indicator 4 does not move to the second divided space, the guidance G is displayed on the display surface 3.

The indicator recognizing unit 21 recognizes that the indicator 4 has moved from the selectable space to the first divided space. The device processing unit 22 commences measuring a time period after the indicator 4 moves to the first divided space. A prescribed time period has been set in the device processing unit 22. The prescribed time period can be arbitrarily set.

When the indicator recognizing unit 21 recognizes that the shape of the indicator 4 has been changed, or when the indicator recognizing unit 21 recognizes that the indicator 4 has moved from the first divided space to the second divided space, the indicator recognizing unit 21 reports the change or the recognition of the movement to the device processing unit 22. When the device processing unit 22 does not receive the report from the indicator recognizing unit 21 even after the prescribed time period has passed, the device processing unit 22 controls the display control unit 25 so as to display the guidance G on the display surface 3.

The user who is used to the operations often changes the shape of the indicator 4 and performs the operations before the prescribed time period has passed. In addition, when the user decides the selection of an object, the user moves the indicator 4 from the first divided space to the second divided space before the prescribed time period has passed. Accordingly, the guidance G is not displayed on the display surface 3, and visibility is not reduced.

On the other hand, when the device processing unit 22 does not receive from the indicator recognizing unit 21 the report indicating that the shape of the indicator 4 has been changed or that the indicator 4 has moved from the first divided space to the second divided space, the display control unit 25 performs control so as to display the guidance G on the display surface 3. As a result, information can be represented to the user who is not used to the operations by using the guidance G.

### Seventh Application Example

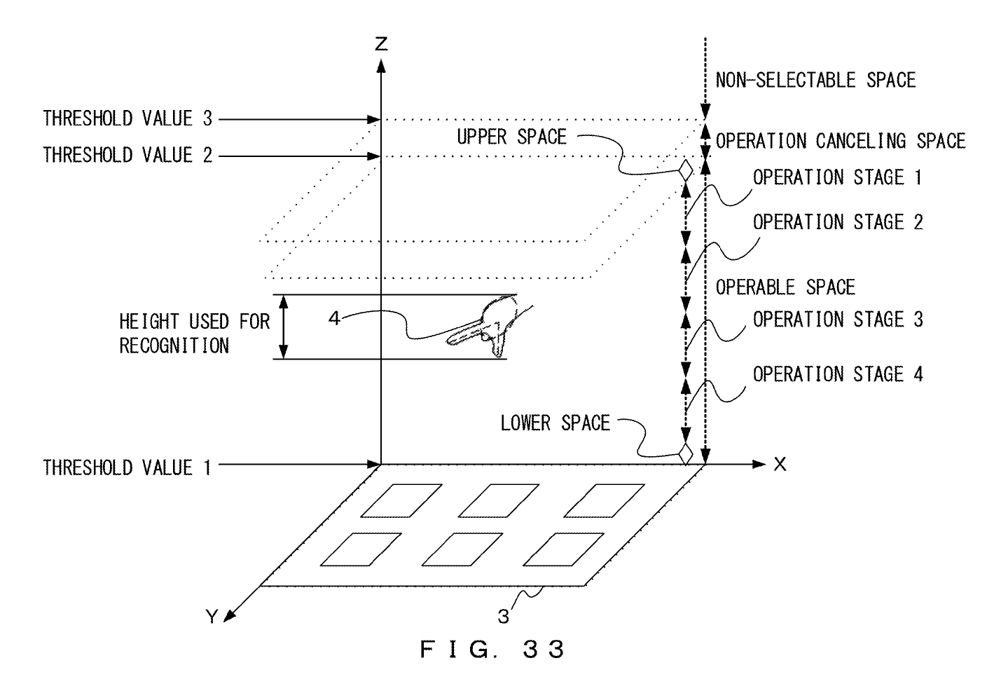

The seventh application example is described next with reference to FIG. 33 through FIG. 36. FIG. 33 illustrates an example of setting of threshold values. FIG. 33 illustrates an example of setting of threshold values for determining an operable space.

In the example of FIG. 33, the operable space is divided into four spaces, an operation stage 1 through an operation stage 4. The spaces at the respective operation stages are spaces for specifying a level for one operation. As an example, when sound volume is operated, the sound volume may be the smallest at the operation stage 1, and may be gradually increased in accordance with the operation stages.

A space for one operation stage has been set in advance. As an example, the space for one operation stage may be set on the basis of operation easiness or the like. A value obtained by multiplying a distance in the Z-axis direction of the space for one operation stage by the number of operation stages is assumed to be a first distance.

In addition, as illustrated in the example of FIG. 33, a height for recognizing the indicator 4 assigned to an operation is assumed to be a second distance. The second distance depends on a size of the indicator 4. The size of the indicator 4 can be recognized by the indicator recognizing unit 21, and therefore the second distance L2 can be determined.

When a space in the Z-axis direction is used for the operation determining operation or the operation canceling operation, a distance in the Z-axis direction used for each of the operations is assumed to be a third distance. In the example of FIG. 33, a Z-axis direction position of a threshold value 1 is located on the display surface 3. Therefore, a space for the operation deciding operation or the operation canceling operation is not set, and the third distance is not used.

When the total sum of the first distance, the second distance, and the third distance is smaller than a Z-axis direction distance of the operable space, the threshold value 1 is set at a position having the third distance from the display surface 3, and a distance between the threshold value 1 and the threshold value 2 is set to be the total sum of the second distance and the third distance.

In the example of FIG. 33, the third distance is not used, and therefore the threshold value 1 is set at a Z-axis direction position of the display surface 3. The threshold value 2 is set at a position having a distance of the total sum of the first distance and the second distance from the threshold value 1.

The first distance is a distance obtained by multiplying a distance for each of the operation stages by 4. The second distance is a height used for recognizing the shape of the indicator 4. In the example of FIG. 33, a space having the second distance is divided into an upper space and a lower space. The total sum of a distance of the upper space and a distance of the lower space in the Z-axis direction is the second distance.

Accordingly, a space based on the total sum of the first distance and the second distance is set to be the operable space. As a result, the operable space sufficient to perform operations at the four stages can be secured. The example of FIG. 33 illustrates setting of threshold values in a case in which operations are assigned in the Z-axis direction.

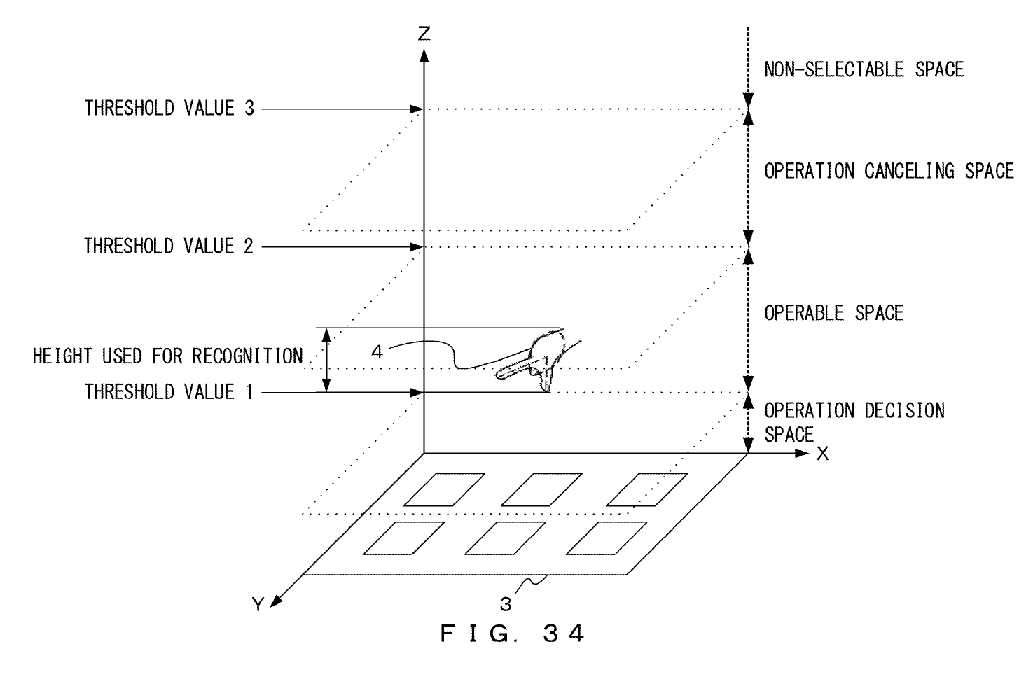

Setting of threshold values in a case in which operations are not assigned in the Z-axis direction is described next with reference to the example of FIG. 34. As illustrated in the example of FIG. 34, an operation deciding space is set on the basis of the display surface 3. Accordingly, the threshold value 1 is set at a position having the third distance from the display surface 3 in the Z-axis direction.

In the example of FIG. 34, operations are not assigned in the Z-axis direction. Accordingly, a plurality of operation stages are not set. The threshold value 2 is set at a position having a distance of the total sum of the first distance and the second distance based on the threshold value 1. A space between the threshold value 1 and the threshold value 2 is set to be the operable space.

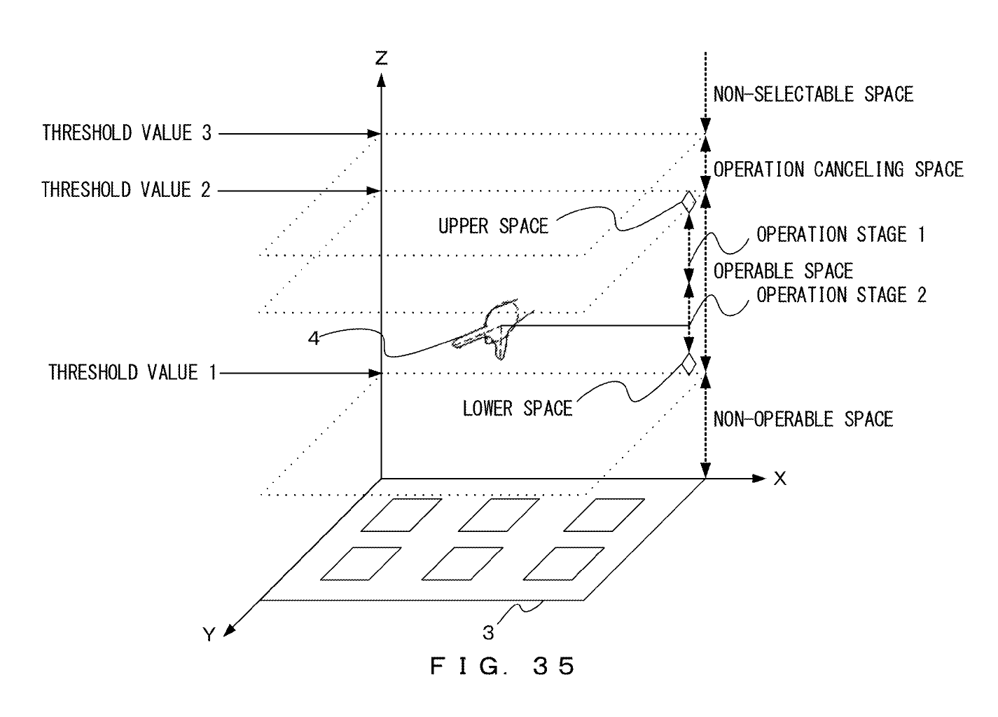

An example of setting of threshold values on a condition at the time of switching the shapes of the indicator 4 is described next with reference to FIG. 35. FIG. 35 illustrates an example in which operations are assigned in the Z-axis direction and there are two operation stages.

In this case, the operable space between the threshold value 1 and the threshold value 2 is set to have a distance of the total sum of the first distance and the second distance. Accordingly, when the threshold value 1 is decided, the threshold value 2 is also decided. The threshold value 1 is set so as to be “third distance+(first distance+second distance−fourth distance)”.

The fourth distance is described. The fourth distance is set to be a distance from a position in the Z-axis direction of the indicator 4 at the time of switching the shapes in which an operation in the upward direction can be performed on an object to be operated. In the example of FIG. 35, for example, it is assumed that, when the indicator 4 is located in a space at the operation stage 2, the shapes of the indicator 4 is switched.

In this case, the fourth direction is set such that the indicator 4 can be moved from the operation stage 2 to the operation stage 1. In the example of FIG. 35, the shapes of the indicator 4 are switched at a position that is relatively far from the display surface 3. Accordingly, the threshold value 1 can secure a certain distance from the display surface 3. In the example of FIG. 35, a space having the threshold value 1 is assumed to be the non-operable space.

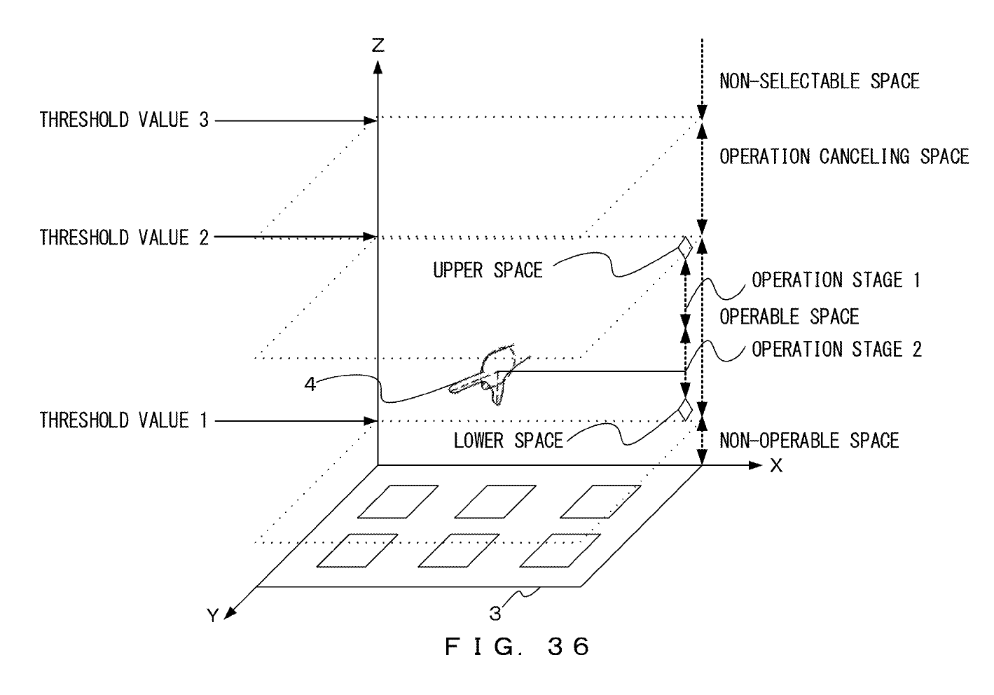

On the other hand, in the example of FIG. 36, the shapes of the indicator 4 are switched at a position that is relatively close to the display surface 3. Accordingly, the threshold value 1 is set at a position that is close to the display surface 3. As described above, threshold values can be set on the basis of a point in time at which the shapes of the indicator 4 are switched.

### Eighth Application Example

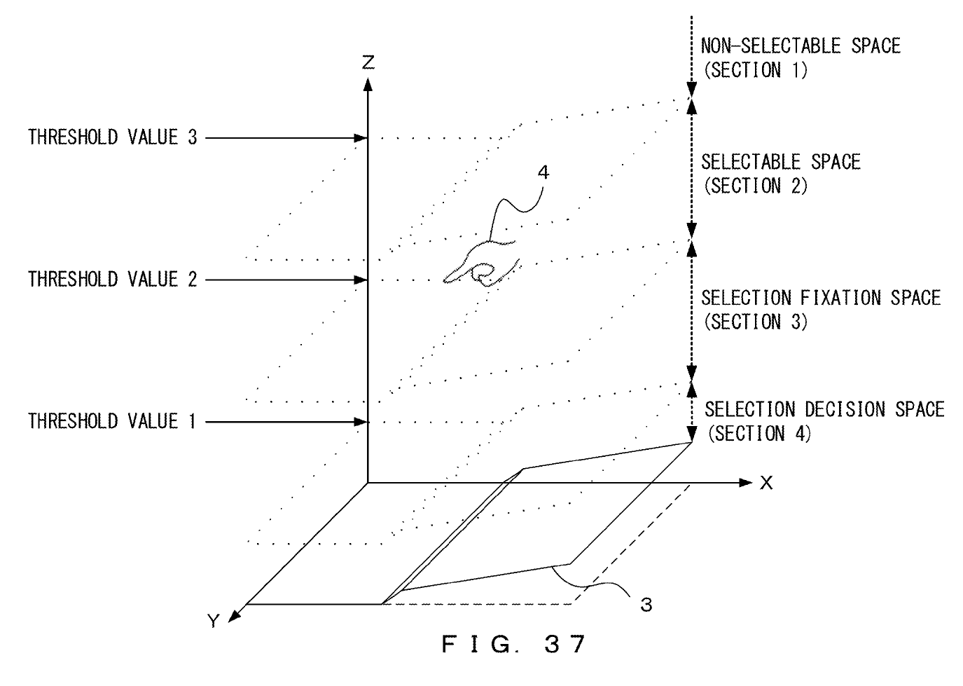

The eighth application example is described next with reference to FIG. 37. As illustrated in the example of FIG. 37, the display surface 3 in the eighth application example has a non-planar shape. The non-selectable space, the selectable space, and the selection fixation space are set along the shape of the display surface 3. The selection decision space is set to be a space between the display surface 3 and a bottom of the selection fixation space.

In the example of FIG. 37, the selection decision space is also set along the shape of the display surface 3. Therefore, the selection decision space corresponding to a non-planar shape section is narrower than the selection decision space corresponding to a planar shape section as illustrated in the example of FIG. 37. As described above, respective spaces can be set even when the display surface 3 does not have a planar shape.

Note that the operable space is also included in the respective spaces set along the non-planar shape of the display surface 3. The shape of the display surface 3 may be recognized by the sensor 5, or may be recognized on the basis of a design value.

### Ninth Application Example

The ninth application example is described next. When the indicator 4 has the selection shape, the display control unit 25 changes a state of information displayed on the display surface 3 in accordance with a space in which the indicator 4 is located.

As an example, the display control unit 25 may change the color of a selected object between cases in which the indicator 4 is located in the selectable space, the selection fixation space, and the selection decision space.

The display control unit 25 may gradually increase transmittances of unselected objects in accordance with a space in which the indicator 4 is located. The display control unit 25 may change a thickness of an edge of a selected object in accordance with a space.

The display control unit 25 may change a display state in accordance with the space by using a dynamic expression. As an example, the display state may be changed in accordance with the space by using, for example, enlargement/reduction, a frame rotating outside an object, flare light, or the like. The display control unit 25 may change the display state in accordance with the space by changing a flickering speed of a selected object.

The display control unit 25 may change a display state of a cursor by which the indication point of the indicator 4 is projected on the display surface in accordance with the space. As an example, the display control unit 25 may rotate the cursor, or may perform ripple-shaped display or the like around the cursor, in accordance with the space.

### <Others>

In the embodiment, the display surface 3 is set on the horizontal plane, but the display surface 3 may be set on an XZ plane, for example. In this case, various spaces are set in the Y-axis direction. Namely, the various spaces may be set in a normal direction of the display surface 3.

According to the embodiment, various input operations using spaces can be realized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An input control device comprising:
a processor that
recognizes a shape of an indicator that performs an operation in a space on an object to be operated that is displayed on a display surface,
specifies an operation assigned to the recognized shape of the indicator, and
changes a size of the space in which the operation is performed in accordance with the specified operation.

2. The input control device according to claim 1, wherein
the operation is assigned to the shape of the indicator or a combination of the shape and a motion of the indicator.

3. The input control device according to claim 1, wherein
the processor performs control to change the size of the space in which the operation is performed between when selecting the object to be operated that is displayed on the display surface and when operating the object to be operated.

4. The input control device according to claim 3, wherein
the processor performs, when the processor recognizes that the indicator is moved from a first space in which the object to be operated is selectable to a second space in which the selected object to be operated is fixed, and that the shape of the indicator is changed from a shape for selection to a shape for the operation, control to change a size of the second space in accordance with the operation.

5. The input control device according to claim 1, wherein
the processor performs control to display a boundary of the space in which the operation is performed.

6. The input control device according to claim 1, wherein
the processor performs control to change the size of the space in which the operation is performed so as to be a space between the display surface and a boundary of the space in which the operation is performable.

7. The input control device according to claim 1, wherein
the processor performs control to sequentially reduce a movement amount of the object to be operated with respect to a movement amount of the indicator after the object to be operated moves outside a space that is set to be narrower than the space in which the object to be operated is operable.

8. The input control device according to claim 1, wherein
the processor performs control to generate sound when the processor recognizes that the indicator is located at the boundary of the space in which the operation is performed.

9. The input control device according to claim 1, wherein
the processor performs, in a case in which the indicator returns to the space in which the operation is performed after the indicator moves outside the space in which the operation is performed, control to validate the operation when the shape of the indicator is the same as the shape before movement, and to cancel the operation when the shape of the indicator is different from the shape before the movement.

10. The input control device according to claim 1, wherein
the processor performs control to display a guidance for the operation, when the space in which the operation is performed is divided into a first divided space and a second divided space, wherein the second divided space is closer than the first divided space to the display surface, and the indicator is located in the first divided space within a prescribed time period.

11. The input control device according to claim 4, wherein
a cursor indicating a position at which an indication point of the indicator is projected is displayed on the display surface, and a display state is changed between when the indication point is located in the first space and when the indication point is located in the second space.

12. The input control device according to claim 11, wherein
the cursor is changed in shape in accordance with a position of the indicator based on the display surface.

13. The input control device according to claim 1, wherein
the space in which the operation is performed is divided into a plurality of stages, and spaces at the respective stages are spaces in which a level of the operation is specified.

14. The input control device according to claim 1, wherein
the display surface is a non-planar shape, and the space in which the operation is performed is set along the non-planer shape.

15. A control method comprising:
recognizing a shape of an indicator that performs an operation in a space on an object to be operated that is displayed on a display surface by a computer;
specifying an operation assigned to the recognized shape of the indicator by the computer; and
changing a size of the space in which the operation is performed in accordance with the specified operation by the computer.

16. A non-transitory computer-readable recording medium having stored therein a control program for causing a computer to execute a process comprising:
recognizing a shape of an indicator that performs an operation in a space on an object to be operated that is displayed on a display surface;
specifying an operation assigned to the recognized shape of the indicator; and
changing a size of the space in which the operation is performed in accordance with the specified operation.
